(19) United States
(12) Patent Application Publication
(10) Pub. No.: US 2017/0011476 A1
(43) Pub. Date: Jan. 12, 2017

(54) GAMIFIED VIDEO LISTING APPLICATION WITH SCAFFOLDED VIDEO PRODUCTION

(71) Applicant: Roofshoot, LLC, Encino, CA (US)

(72) Inventor: Benjamin Harry Bacal, Los Angeles, CA (US)

(21) Appl. No.: 14/794,651

(22) Filed: Jul. 8, 2015

(51) Int. Cl. G06Q 50/16; G06Q 30/06; H04N 5/76; G06F 3/0484; G11B 27/02; G11B 27/00

(52) U.S. Cl. CPC G06Q 50/16; G11B 27/02; G11B 27/002; H04N 5/76; G06F 3/04847; G06Q 30/06

(57) ABSTRACT

Described are systems, media, and methods for providing high quality, gamified real estate video listings by providing an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; providing a map view interface comprising video listings; and awarding points for user activity within the application, the user activity comprising creation of video listings, the points used to allocate user promotions.

### BACKGROUND OF THE INVENTION

Over the last decade, the Internet has seeped into the bedrock of the U.S. economy: the housing market. Four sites—Redfin and Zillow, based in Seattle, and Trulia and Realtor.com, based in the San Francisco Bay Area—attract 61 million of the 67 million visitors to real estate websites each month in the U.S., according to ComScore. Ninety percent of consumers now start their real estate journey on the Web, according to the National Association of Realtors.

### SUMMARY OF THE INVENTION

Existing real estate applications focus on real properties themselves, but give few incentives for professionals to promote other local features, the neighborhood, or the community as a whole. In contrast, the subject matter presented herein provides that in addition to listing properties for sale, a listing agent gets the chance to list neighborhood tours and/or neighborhood locations. As described herein, in some embodiments, an agent is rewarded (e.g. in the form of points, etc.) for providing approved neighborhood tours and/or neighborhood locations. Buyers benefit from an opportunity to learn not only about listed properties, but also hotspots and features within the community.

The subject matter described herein further provides an interface for a user to create a video listing for property walkthroughs, neighborhood tours, and/or neighborhood locations. The interface comprises an interactive scaffolded video template comprising a plurality of sequenced video sections, each section defining a subject matter and a video length, and upon activation by a user, facilitating acquisition of a corresponding video clip. This provides real estate professionals with convenient tools to create high production quality video not previously accessible to them. As described herein, in some embodiments, the interactive scaffolded video templates include video sections such as one or more of introduction, walk through, and wrap-up, as well as variable optional video sections to best promote impressive features of properties and neighborhood features. Buyers benefit from a much improved user experience and gain first-hand knowledge before going to see a property in person.

The subject matter described herein further provides real estate professionals an interface to offer price opinions on others' listed properties. This is extremely helpful in the high-end housing market where properties are often unique and there are few similar properties available for reference. Price opinions help set a more marketable price and give guidance to buyers. As described herein, in some embodiments, an agent is rewarded (e.g. in the form of points, etc.) for providing an approved price opinion. In further embodiments, an agent's ranking in the real estate listing application is improved by earning points.

In one aspect, disclosed herein are computer-implemented systems for gamified real estate video listing comprising: a digital processing device comprising an operating system configured to perform executable instructions and a memory; a computer program including instructions executable by the digital processing device to create a video listing application comprising: a software module configured to present an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; a software module configured to present a map view interface comprising video listings; and a software module configured to award points for user activity within the application, the user activity comprising creation of video listings, the points used to allocate user promotions. In some embodiments, the application further comprises a software module configured to present an interface for creating a user profile, the profile an agent profile or a consumer profile. In some embodiments, each video is acquired by recording video via the processing device, recording video via an external device, or selecting a pre-recorded video from a storage. In some embodiments, video acquisition is terminated at the end of the defined video length for each section. In some embodiments, the interactive scaffolded video template comprises mandatory and optional video sections. In some embodiments, the interactive scaffolded video template comprises variable sections, wherein the user indicates the number of video clips in the section. In some embodiments, the application comprises a separate interactive scaffolded video template for each of the listing types: property walkthrough, neighborhood tour, and neighborhood location. In further embodiments, the property walkthrough scaffolded template comprises one or more of: introduction, walkthrough, kitchen, bathroom, outdoors, bedrooms, other rooms, exterior amenities, and wrap up. In further embodiments, the neighborhood location scaffolded template comprises one or more of: overview, additional videos, and wrap up. In some embodiments, the interactive scaffolded video template comprises tools to trim acquired video clips. In some embodiments, the interactive scaffolded video template comprises tools to add a theme to the video. In some embodiments, the interactive scaffolded video template comprises tools to add music to the video. In some embodiments, the interactive scaffolded video template comprises tools to add a voiceover to the video. In some embodiments, the application further comprises an interface for allowing a first user to request a price opinion for a listed property and an interface for a second user to submit a price opinion for the listed property. In some embodiments, the points are awarded for one or more of: creating a profile, creating a profile video, creating a property walkthrough video, creating a neighborhood tour video, creating a neighborhood location video, providing a price opinion, and marking a video listing as sold.

In another aspect, disclosed herein are non-transitory computer-readable storage media encoded with a computer program including instructions executable by a processor to create an application for gamified real estate video listing comprising: a software module configured to present an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; a software module configured to present a map view interface comprising video listings; and a software module configured to award points for user activity within the application, the user activity comprising creation of video listings, the points used to allocate user promotions. In some embodiments, the application further comprises a software module configured to present an interface for creating a user profile, the profile an agent profile or a consumer profile. In some embodiments, each video is acquired by recording video via the processing device, recording video via an external device, or selecting a pre-recorded video from a storage. In some embodiments, video acquisition is terminated at the end of the defined video length for each section. In some embodiments, the interactive scaffolded video template comprises mandatory and optional video sections. In some embodiments, the interactive scaffolded video template comprises variable sections, wherein the user indicates the number of video clips in the section. In some embodiments, the application comprises a separate interactive scaffolded video template for each of the listing types: property walkthrough, neighborhood tour, and neighborhood location. In further embodiments, the property walkthrough scaffolded template comprises one or more of: introduction, walkthrough, kitchen, bathroom, outdoors, bedrooms, other rooms, exterior amenities, and wrap up. In further embodiments, the neighborhood location scaffolded template comprises one or more of: overview, additional videos, and wrap up. In some embodiments, the interactive scaffolded video template comprises tools to trim acquired video clips. In some embodiments, the interactive scaffolded video template comprises tools to add a theme to the video. In some embodiments, the interactive scaffolded video template comprises tools to add music to the video. In some embodiments, the interactive scaffolded video template comprises tools to add a voiceover to the video. In some embodiments, the application further comprises an interface for allowing a first user to request a price opinion for a listed property and an interface for a second user to submit a price opinion for the listed property. In some embodiments, the points are awarded for one or more of: creating a profile, creating a profile video, creating a property walkthrough video, creating a neighborhood tour video, creating a neighborhood location video, providing a price opinion, and marking a video listing as sold.

In another aspect, disclosed herein are computer-implemented methods of providing high quality, gamified real estate video listings comprising: providing, by a computer, an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; providing, by the computer, a map view interface comprising video listings; and awarding, by the computer, points for user activity within the application, the user activity comprising creation of video listings, the points used to allocate user promotions. In some embodiments, the method further comprises providing, by the computer, an interface for creating a user profile, the profile an agent profile or a consumer profile. In some embodiments, each video is acquired by recording video via the processing device, recording video via an external device, or selecting a pre-recorded video from a storage. In some embodiments, video acquisition is terminated at the end of the defined video length for each section. In some embodiments, the interactive scaffolded video template comprises mandatory and optional video sections. In some embodiments, the interactive scaffolded video template comprises variable sections, wherein the user indicates the number of video clips in the section. In some embodiments, the application comprises a separate interactive scaffolded video template for each of the listing types: property walkthrough, neighborhood tour, and neighborhood location. In further embodiments, the property walkthrough scaffolded template comprises one or more of: introduction, walkthrough, kitchen, bathroom, outdoors, bedrooms, other rooms, exterior amenities, and wrap up. In further embodiments, the neighborhood location scaffolded template comprises one or more of: overview, additional videos, and wrap up. In some embodiments, the interactive scaffolded video template comprises tools to trim acquired video clips. In some embodiments, the interactive scaffolded video template comprises tools to add a theme to the video. In some embodiments, the interactive scaffolded video template comprises tools to add music to the video. In some embodiments, the interactive scaffolded video template comprises tools to add a voiceover to the video. In some embodiments, the method further comprises providing, by the computer, an interface for allowing a first user to request a price opinion for a listed property and an interface for a second user to submit a price opinion for the listed property. In some embodiments, the points are awarded for one or more of: creating a profile, creating a profile video, creating a property walkthrough video, creating a neighborhood tour video, creating a neighborhood location video, providing a price opinion, and marking a video listing as sold.

### BRIEF DESCRIPTION OF THE DRAWINGS

FIG. 1 shows a non-limiting example of an interface for gamified real estate video listing; in this case, a listing and sales initial experience interface allowing an agent to create and manage his real estate listings.

FIG. 2 shows a non-limiting example of an interface for gamified real estate video listing; in this case, an account and profile interface allowing a user to manage app settings, account profiles, tutorials, rules, and app ratings, among others.

FIG. 3 shows a non-limiting example of an interface for gamified real estate video listing; in this case, a listings and sales interface allowing an agent to edit, view, sort, filter, revert and delete listings and sales wherein the listings are in different listing states including: submitted & rejected, submitted & pending, draft (submit-ready), draft (not submit-ready) and approved.

FIG. 4 shows a non-limiting example of an interface for gamified real estate video listing; in this case, a listings creating interface allowing an agent to enter a property address.

FIG. 5 shows a non-limiting example of an interface for gamified real estate video listing; in this case, a listings creating interface allowing an agent to adjust a property pin location.

FIG. 6 shows a non-limiting example of an interface for gamified real estate video listing; in this case, a listings and sales interface allowing an agent to edit a property address & location.

FIG. 7 shows a non-limiting example of an interface for gamified real estate video listing; in this case, a listings and sales interface allowing an agent to add and edit property videos.

FIG. 8 shows a non-limiting example of an interface for gamified real estate video listing; in this case, a video authoring interface allowing an agent to add and edit a theme to property videos.

FIG. 9 shows a non-limiting example of an interface for gamified real estate video listing; in this case, a video authoring interface allowing an agent to edit and choose different themes for property videos.

FIG. 10 shows a non-limiting example of an interface for gamified real estate video listing; in this case, a video authoring interface allowing an agent to add and edit introduction videos for a property.

FIG. 11 shows a non-limiting example of an interface for gamified real estate video listing; in this case, a video authoring interface allowing an agent to shoot, add and edit introduction videos for a property, wherein an interactive scaffolded video template comprises introduction video sections including a 25-seconds overview video of the property and a 3-seconds video to show impressive features of the property.

FIG. 12 shows a non-limiting example of an interface for gamified real estate video listing; in this case, a video authoring interface allowing an agent to shoot, add and edit introduction videos for a property, wherein an interactive scaffolded video template comprises optional introduction video sections showing additional impressive features of the property.

FIG. 13 shows a non-limiting example of an interface for gamified real estate video listing; in this case, a video authoring interface allowing an agent to add and edit mandatory walkthrough videos for a property.

FIG. 14 shows a non-limiting example of an interface for gamified real estate video listing; in this case, a video authoring interface allowing an agent to shoot, add and edit mandatory walkthrough videos for a property, wherein an interactive scaffolded video template comprises mandatory and optional walkthrough video sections.

FIG. 15 shows a non-limiting example of an interface for gamified real estate video listing; in this case, a video authoring interface allowing an agent to shoot, add and edit mandatory walkthrough videos for a property, wherein a mobile phone camera is pressed and held to record a walkthrough video.

FIG. 16 shows a non-limiting example of an interface for gamified real estate video listing; in this case, a video authoring interface allowing an agent to add and edit mandatory walkthrough videos for a property, wherein a video clip is shortened and edited.

FIG. 17 shows a non-limiting example of an interface for gamified real estate video listing; in this case, a video authoring interface allowing an agent to shoot, add and edit optional videos for a property, including kitchen, bathroom, outdoors, bedrooms, other rooms and exterior amenities.

FIG. 18 shows a non-limiting example of an interface for gamified real estate video listing; in this case, a video authoring interface allowing an agent to shoot, add and edit optional videos for a property, wherein an interactive scaffolded video template comprises kitchen video sections.

FIG. 19 shows a non-limiting example of an interface for gamified real estate video listing; in this case, a video authoring interface allowing an agent to add and edit mandatory wrap-up videos for a property.

FIG. 20 shows a non-limiting example of an interface for gamified real estate video listing; in this case, a video authoring interface allowing an agent to shoot, add and edit mandatory wrap-up videos for a property, wherein an interactive scaffolded video template comprises wrap-up video sections wrapping up best aspects of the property.

FIG. 21 shows a non-limiting example of an interface for gamified real estate video listing; in this case, a video authoring interface allowing an agent to add and edit thumbnail images for a property.

FIG. 22 shows a non-limiting example of an interface for gamified real estate video listing; in this case, a video authoring interface allowing an agent to add and edit thumbnail images for a property, wherein an interactive scaffolded video template comprises thumbnail image cells for the editing.

FIG. 23 shows a non-limiting example of an interface for gamified real estate video listing; in this case, a video authoring interface allowing an agent to add a video title for a property.

FIG. 24 shows a non-limiting example of an interface for gamified real estate video listing; in this case, a video authoring interface allowing an agent to edit a video title for a property.

FIG. 25 shows a non-limiting example of an interface for gamified real estate video listing; in this case, a listings and sales interface allowing an agent to view and manage listing states of a property, wherein the listing state is draft (submit-ready).

FIG. 26 shows a non-limiting example of an interface for gamified real estate video listing; in this case, a listings and sales interface allowing an agent to view and manage listing states of a property, wherein the listing state is submitted & pending.

FIG. 27 shows a non-limiting example of an interface for gamified real estate video listing; in this case, a listings and sales interface allowing an agent to view and manage listing states of a property, wherein the listing state is submitted & rejected/flagged.

FIG. 28 shows a non-limiting example of an interface for gamified real estate video listing; in this case, a listings and sales interface allowing an agent to view and manage listing states of a property, wherein the listing state is approved.

FIG. 29 shows a non-limiting example of an interface for gamified real estate video listing; in this case, a listings and sales interface allowing an agent to view and manage listing states of a property, wherein an approved listing state needs to be re-submitted when videos are added, edited or deleted.

FIG. 30 shows a non-limiting example of an interface for gamified real estate video listing; in this case, a listing and sales initial experience interface allowing an agent to create and manage neighborhood cool spot listings.

FIG. 31 shows a non-limiting example of an interface for gamified real estate video listing; in this case, a listings creating interface allowing an agent to enter a neighborhood cool spot address.

FIG. 32 shows a non-limiting example of an interface for gamified real estate video listing; in this case, a listings creating interface allowing an agent to adjust a neighborhood cool spot pin location.

FIG. 33 shows a non-limiting example of an interface for gamified real estate video listing; in this case, a listings and sales interface allowing an agent to edit a neighborhood cool spot address & location.

FIG. 34 shows a non-limiting example of an interface for gamified real estate video listing; in this case, a listings and sales interface allowing an agent to add and edit a neighborhood cool spot description.

FIG. 35 shows a non-limiting example of an interface for gamified real estate video listing; in this case, a listings and sales interface allowing an agent to edit a neighborhood cool spot description.

FIG. 36 shows a non-limiting example of an interface for gamified real estate video listing; in this case, a listings and sales interface allowing an agent to add and edit neighborhood cool spot videos.

FIG. 37 shows a non-limiting example of an interface for gamified real estate video listing; in this case a video authoring interface allowing an agent to add and edit a theme to a neighborhood cool spot video.

FIG. 38 shows a non-limiting example of an interface for gamified real estate video listing; in this case, a video authoring interface allowing an agent to edit and choose different themes for a neighborhood cool spot video.

FIG. 39 shows a non-limiting example of an interface for gamified real estate video listing; in this case, a video authoring interface allowing an agent to add and edit overview videos for a neighborhood cool spot.

FIG. 40 shows a non-limiting example of an interface for gamified real estate video listing; in this case, a video authoring interface allowing an agent to shoot, add and edit overview videos for a neighborhood cool spot, wherein an interactive scaffolded video template comprises overview video sections including a long 25-seconds overview video and a short 3-seconds overview video of the neighborhood cool spot.

FIG. 41 shows a non-limiting example of an interface for gamified real estate video listing; in this case, a video authoring interface allowing an agent to shoot, add and edit overview videos for a neighborhood cool spot, wherein an interactive scaffolded video template comprises optional overview video sections showing additional overview of the neighborhood cool spot.

FIG. 42 shows a non-limiting example of an interface for gamified real estate video listing; in this case, a video authoring interface allowing an agent to add and edit optional additional videos for a neighborhood cool spot.

FIG. 43 shows a non-limiting example of an interface for gamified real estate video listing; in this case, a video authoring interface allowing an agent to shoot, add and edit additional videos for a neighborhood cool spot, wherein an interactive scaffolded video template comprises optional neighborhood cool spot clip sections.

FIG. 44 shows a non-limiting example of an interface for gamified real estate video listing; in this case, a web-based homepage of a general user allowing the user to browse listings, agents, videos and other information.

FIG. 45 shows a non-limiting example of an interface for gamified real estate video listing; in this case, a mobile homepage of a general user allowing the user to browse listings, agents, videos and other information.

FIG. 46 shows a non-limiting example of an interface for gamified real estate video listing; in this case, a web-based homepage of a logged-in agent allowing the agent to create and browse listings, agents, videos and other information.

FIG. 47 shows a non-limiting example of an interface for gamified real estate video listing; in this case, a web-based map and list view of search results of properties, neighborhood cool spots and tours within a specified zip code.

FIG. 48A shows a non-limiting example of an interface for gamified real estate video listing; in this case, a mobile map view of search results of properties, neighborhood cool spots and tours within a specified zip code.

FIG. 48B shows a non-limiting example of an interface for gamified real estate video listing; in this case, a mobile list view of search results of properties, neighborhood cool spots and tours within a specified zip code.

FIG. 49 shows a non-limiting example of an interface for gamified real estate video listing; in this case, a web-based map and list view of search results of properties, neighborhood cool spots and tours within a specified zip code with advanced filtering parameters.

FIG. 50 shows a non-limiting example of an interface for gamified real estate video listing; in this case, a web-based map view of search results of properties, neighborhood cool spots and tours within a specified zip code, wherein the view is focused on listing agents.

FIG. 51 shows a non-limiting example of an interface for gamified real estate video listing; in this case, a web-based map and list view of search results of properties, neighborhood cool spots and tours within a specified zip code, wherein a quick view is provided when a user clicks or taps on an item on the map.

FIG. 52 shows a non-limiting example of an interface for gamified real estate video listing; in this case, a web-based detailed view of a property.

FIG. 53 shows a non-limiting example of an interface for gamified real estate video listing; in this case, a mobile detailed view of a property.

FIG. 54 shows a non-limiting example of an interface for gamified real estate video listing; in this case, a web-based detailed view of a property with the display of nearby schools, cool spots, neighborhood tours and similar properties.

FIG. 55 shows a non-limiting example of an interface for gamified real estate video listing; in this case, a web-based detailed view of a neighborhood cool spot.

FIG. 56 shows a non-limiting example of an interface for gamified real estate video listing; in this case, a mobile detailed view of a neighborhood cool spot.

FIG. 57 shows a non-limiting example of an interface for gamified real estate video listing; in this case, a web-based detailed view of a neighborhood cool spot with the display of nearby schools, cool spots, neighborhood tours and properties.

FIG. 58 shows a non-limiting example of an interface for gamified real estate video listing; in this case, an interface allowing a user to search and browse agents.

FIG. 59 shows a non-limiting example of an interface for gamified real estate video listing; in this case, a detailed view of an agent profile displaying her bio, listings, sales, cool spots, local tours, knowledge-based videos and price opinions.

FIG. 60 shows a non-limiting example of an interface for gamified real estate video listing; in this case, a detailed view of an agent profile displaying reviews of the agent.

FIG. 61 shows a non-limiting example of an interface for gamified real estate video listing; in this case, a web-based view of an agent dashboard displaying activity feed of the agent.

FIG. 62 shows a non-limiting example of an interface for gamified real estate video listing; in this case, a mobile view of an agent dashboard displaying activity feed of the agent.

FIG. 63 shows a non-limiting example of an interface for gamified real estate video listing; in this case, a web-based view of an agent dashboard displaying message center of the agent.

FIG. 64 shows a non-limiting example of an interface for gamified real estate video listing; in this case, a mobile view of an agent dashboard displaying the agent's price opinions.

FIG. 65 shows a non-limiting example of an interface for gamified real estate video listing; in this case, a mobile view of an agent dashboard allowing the agent to create, update and submit price opinions.

FIG. 66 shows a non-limiting example of an interface for gamified real estate video listing; in this case, a mobile view of an agent dashboard displaying points earned by the agent after submitting price opinions.

FIG. 67 shows a non-limiting example of an interface for gamified real estate video listing; in this case, a mobile view of an agent dashboard displaying price opinions requests.

FIG. 68 shows a non-limiting example of an interface for gamified real estate video listing; in this case, a web-based detailed view of an agent's listings and sales.

FIG. 69 shows a non-limiting example of an interface for gamified real estate video listing; in this case, a mobile detailed view of an agent's listings and sales.

FIG. 70 shows a non-limiting example of an interface for gamified real estate video listing; in this case, an interface of a buyer's dashboard displaying the buyer's recently viewed listings and recommended properties for the buyer.

FIG. 71 shows a non-limiting example of an interface for gamified real estate video listing; in this case, an interface of a buyer's dashboard displaying the buyer's favorite properties and videos.

FIG. 72 shows a non-limiting example of an interface for gamified real estate video listing; in this case, an interface of a buyer's dashboard displaying price opinions of the buyer's viewed properties.

### DETAILED DESCRIPTION OF THE INVENTION

Described herein, in certain embodiments, are computer-implemented systems for gamified real estate video listing comprising: a digital processing device comprising an operating system configured to perform executable instructions and a memory; a computer program including instructions executable by the digital processing device to create a video listing application comprising: a software module configured to present an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; a software module configured to present a map view interface comprising video listings; and a software module configured to award points for user activity within the application, the user activity comprising creation of video listings, the points used to allocate user promotions.

Also described herein, in certain embodiments, are non-transitory computer-readable storage media encoded with a computer program including instructions executable by a processor to create an application for gamified real estate video listing comprising: a software module configured to present an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; a software module configured to present a map view interface comprising video listings; and a software module configured to award points for user activity within the application, the user activity comprising creation of video listings, the points used to allocate user promotions.

Also described herein, in certain embodiments, are computer-implemented methods of providing high quality, gamified real estate video listings comprising: providing, by a computer, an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; providing, by the computer, a map view interface comprising video listings; and awarding, by the computer, points for user activity within the application, the user activity comprising creation of video listings, the points used to allocate user promotions.

Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Listings and Sales

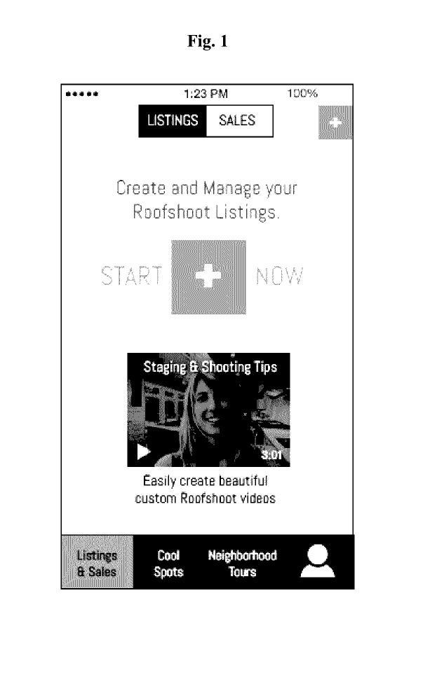

In some embodiments, the systems, media, and methods described herein include listings and sales, or use of the same. In some embodiments, an agent lists all his clients' properties in the application. Referring to FIG. 1, in a particular embodiment, a listing and sales initial experience interface is provided to allow an agent to create and manage his real estate listings.

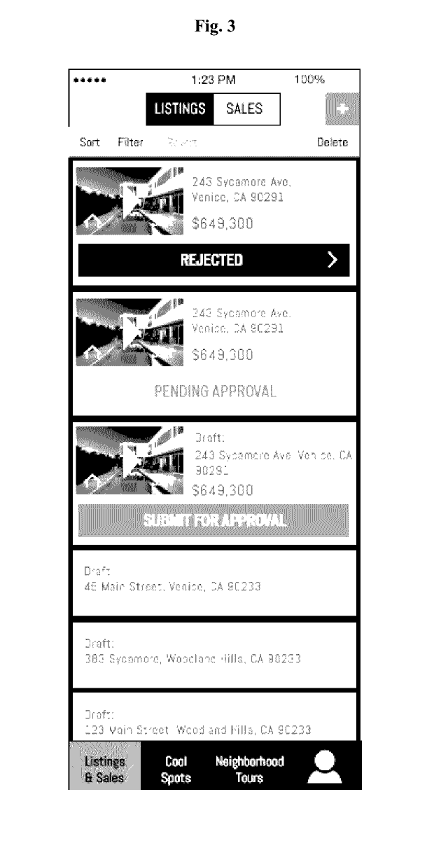

In some embodiments, all listings begin as “drafts” and are edited and saved over time under “listings” section in both the agent's app and web dashboard. In some embodiments, once an agent submits a “draft” for approval, an administrator of the app will either approve or reject it. Until approval, the listing is flagged as “pending.” In some embodiments, once a listing is approved, simple edits will publish instantly. In other embodiments, if a listing video is edited, the listing needs to be re-submitted for approval. In some embodiments, when a listed property is “sold”, the listing remains archived under the “sales” section. Referring to FIG. 3, in a particular embodiment, a listings and sales interface is provided to allow an agent to edit, view, sort, filter, revert and delete listings and sales wherein the listings are in different listing states including: submitted & rejected, submitted & pending, draft (submit-ready), draft (not submit-ready) and approved.

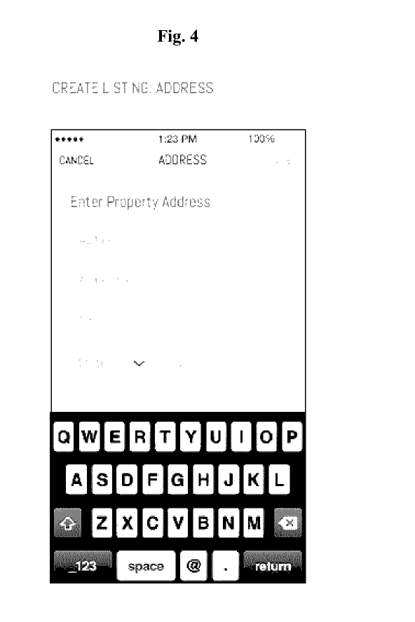

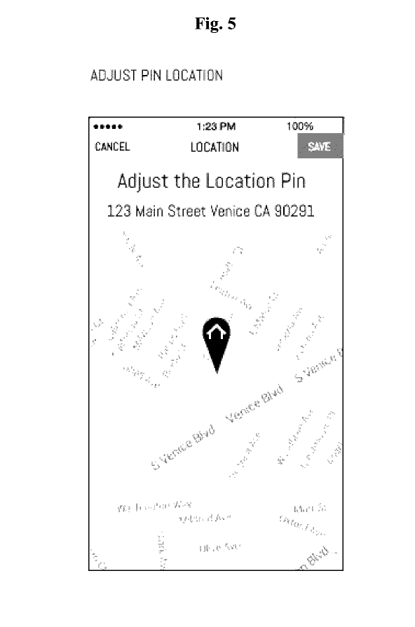

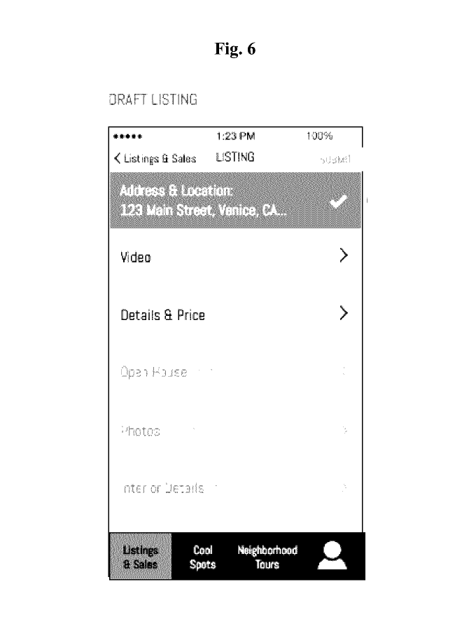

Referring to FIG. 4, in a particular embodiment, a listings creating interface is provided to allow an agent to enter a property address. Referring to FIG. 5, in a particular embodiment, a listings creating interface is provided to allow an agent to adjust a property pin location. Referring to FIG. 6, in a particular embodiment, a listings and sales interface is provided to allow an agent to edit a property address & location.

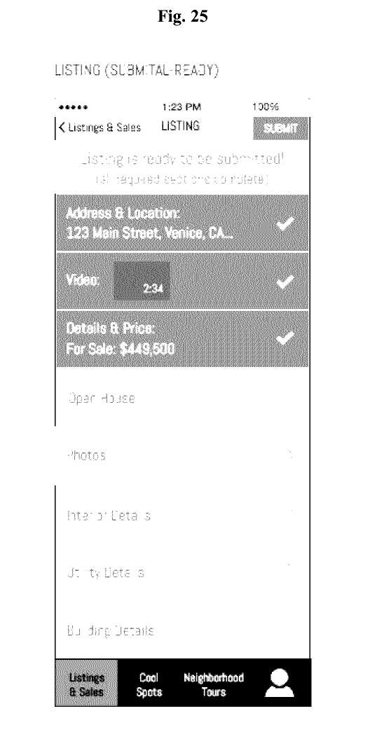

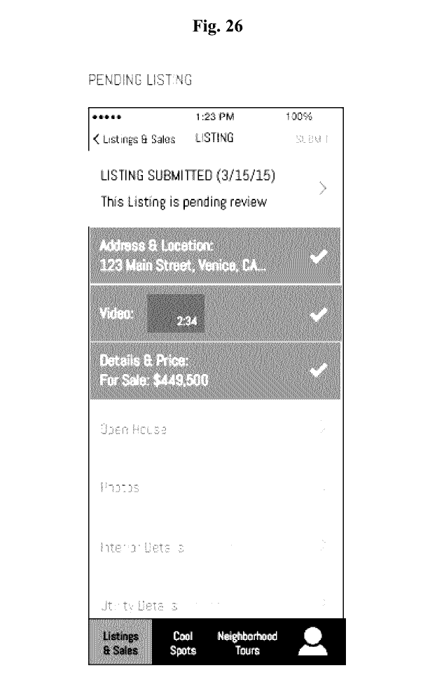

Referring to FIG. 25, in a particular embodiment, a listings and sales interface is provided to allow an agent to view and manage listing states of a property, wherein the listing state is draft (submit-ready). Referring to FIG. 26, in a particular embodiment, a listings and sales interface is provided to allow an agent to view and manage listing states of a property, wherein the listing state is submitted & pending. In some embodiments, a user makes instant edits to anything other than videos on a pending listing without the need to re-submit. In some embodiments, a pending listing needs to be re-submitted when videos of a listing are edited.

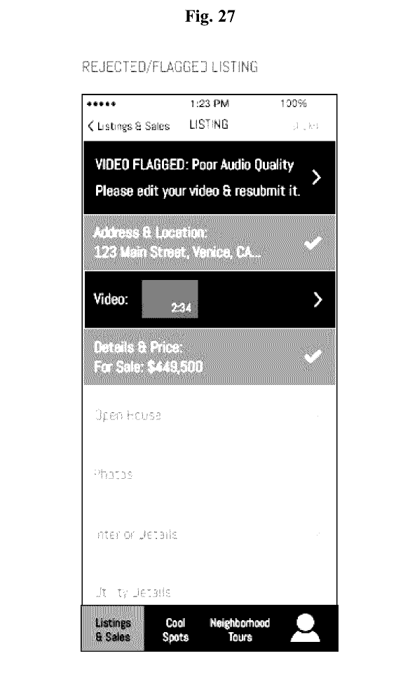

Referring to FIG. 27, in a particular embodiment, a listings and sales interface is provided to allow an agent to view and manage listing states of a property, wherein the listing state is submitted & rejected/flagged. In some embodiments, a listing is rejected or flagged when there is a rejected video. In some embodiments, a listing is ready for re-submit when the rejected video is updated.

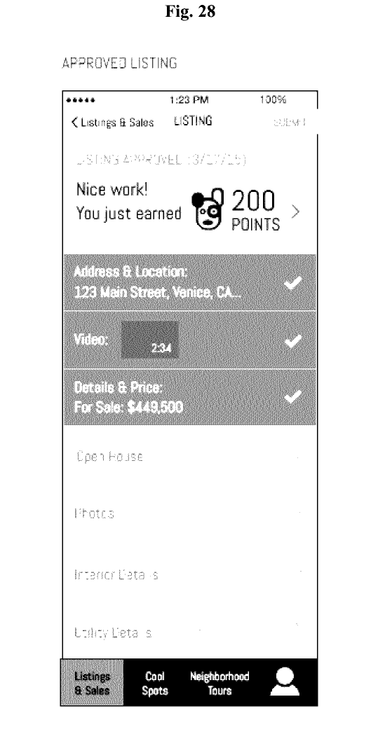

Referring to FIG. 28, in a particular embodiment, a listings and sales interface is provided to allow an agent to view and manage listing states of a property, wherein the listing state is approved. In some embodiments, an agent changes a property's status to hold, withdrawn, etc. In some embodiments, when a user makes instant edits to anything other than videos on an approved listing, there is no need to re-submit.

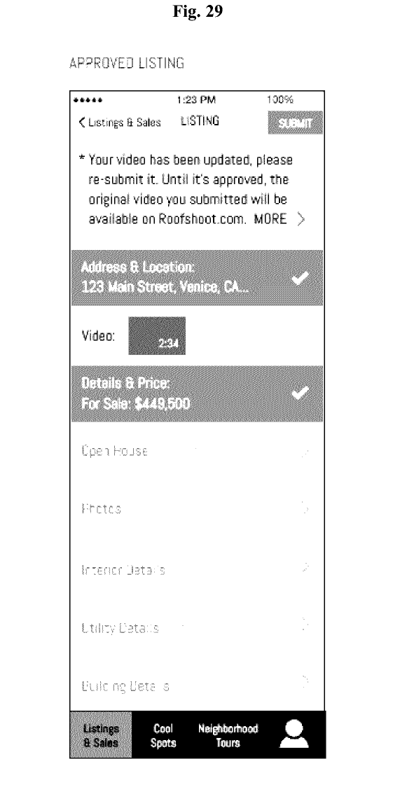

Referring to FIG. 29, in a particular embodiment, a listings and sales interface is provided to allow an agent to view and manage listing states of a property, wherein an approved listing state needs to be re-submitted when videos are added, edited or deleted.

In some embodiments, listings and sales of cool spots and neighborhood tours follow the same rules of listings and sales of properties, except the change to “sales” section when a property is sold.

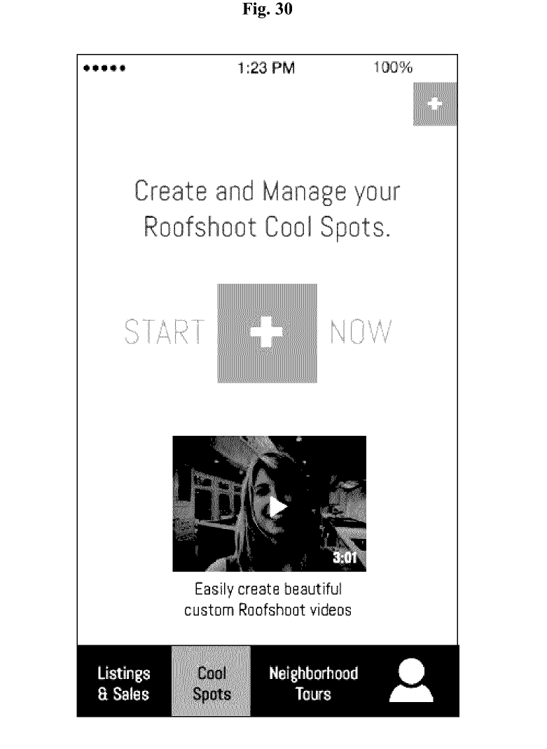

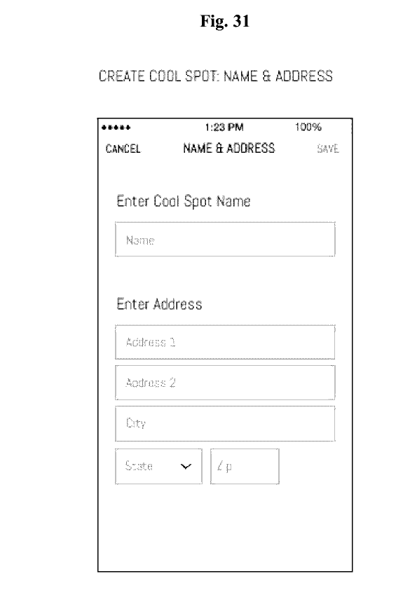

Referring to FIG. 30, in a particular embodiment, a listing and sales initial experience interface is provided to allow an agent to create and manage neighborhood cool spot listings. Referring to FIG. 31, in a particular embodiment, a listings creating interface is provided to allow an agent to enter a neighborhood cool spot address. In some embodiments, a cool spot comprises mandatory components to be “complete” for submit. In further embodiments, mandatory components of a cool spot include, by way of non-limiting examples, name, address and location; videos; and description.

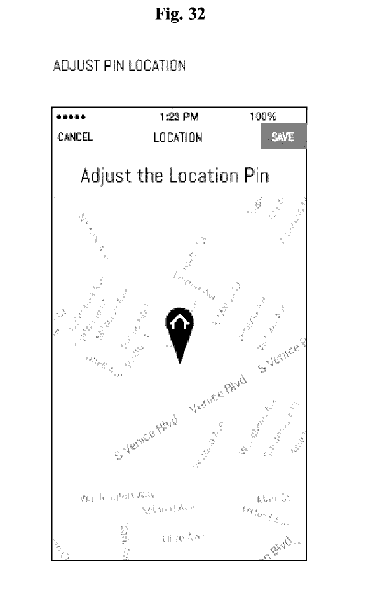

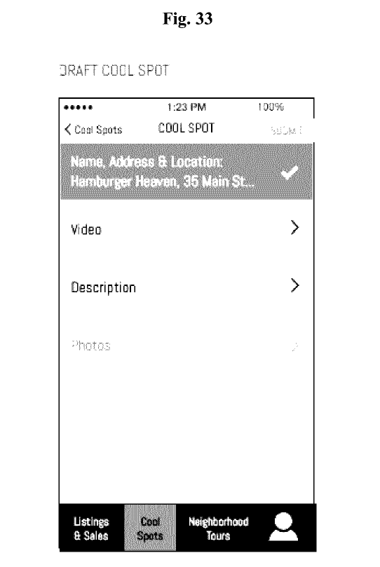

Referring to FIG. 32, in a particular embodiment, a listings creating interface is provided to allow an agent to adjust a neighborhood cool spot pin location. Referring to FIG. 33, in a particular embodiment, a listings and sales interface is provided to allow an agent to edit a neighborhood cool spot address & location.

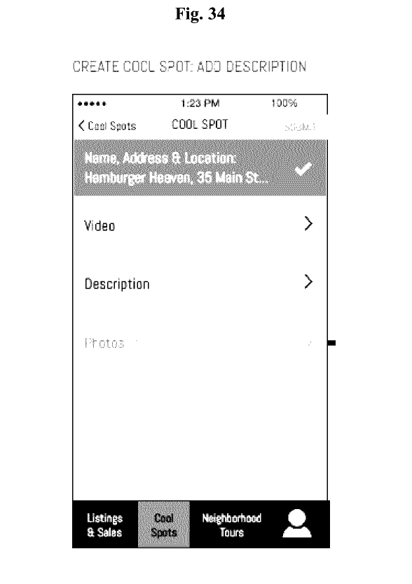

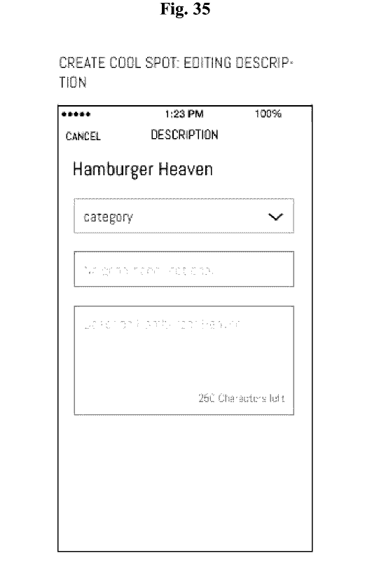

Referring to FIG. 34, in a particular embodiment, a listings and sales interface is provided to allow an agent to add and edit a neighborhood cool spot description. Referring to FIG. 35, in a particular embodiment, a listings and sales interface is provided to allow an agent to edit a neighborhood cool spot description. In some embodiments, a partial description is deemed “incomplete” and is not checked to be ready for submit.

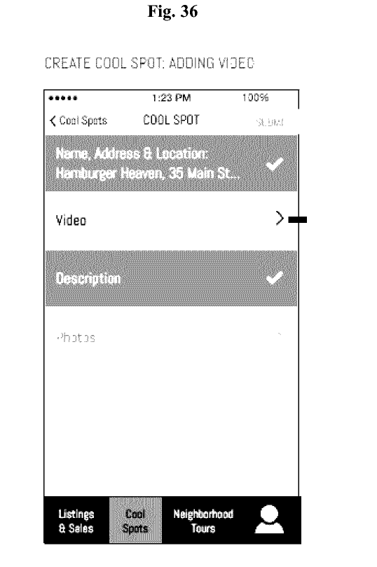

Referring to FIG. 36, in a particular embodiment, a listings and sales interface is provided to allow an agent to add and edit neighborhood cool spot videos.

Video Listing

In some embodiments, the systems, media, and methods described herein include video listings, or use of the same. In some embodiments, a computer-implemented system for gamified real estate video listing is hereby provided. In some embodiments, the computer-implemented system for gamified real estate video listing comprises a video listing application. In some embodiments, the video listing application comprises: a software module configured to present an interface for creating a video listing, the video listing of a type selected from: property walkthrough, neighborhood tour, or neighborhood location, the interface comprising an interactive scaffolded video template comprising a plurality of sequenced video sections, each section defining a subject matter and a video length and, upon activation by a user, facilitating acquisition of a corresponding video clip; a software module configured to present a map view interface comprising video listings; and a software module configured to award points for user activity within the application, the user activity comprising creation of video listings, the points used to allocate user promotions.

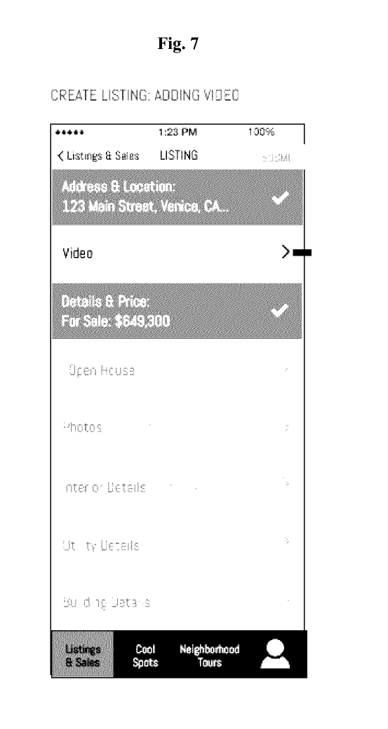

Referring to FIG. 7, in a particular embodiment, a listings and sales interface is provided to allow an agent to add and edit property videos. In some embodiments, a video is acquired by recording video via the processing device. In some embodiments, a video is acquired by recording video via an external device. In some embodiments, a video is acquired by or selecting a pre-recorded video from a storage.

In some embodiments, the defined video length (e.g., duration) is a suggested or recommended video length. In further embodiments, the interactive scaffolded video template does not have a video length requirement for any video section. In other embodiments, the defined video length is required video length. In further embodiments, the interactive scaffolded video template requires a defined video length for each video section.

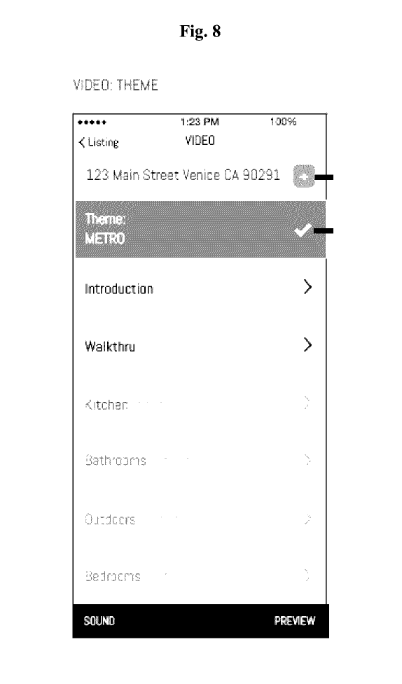

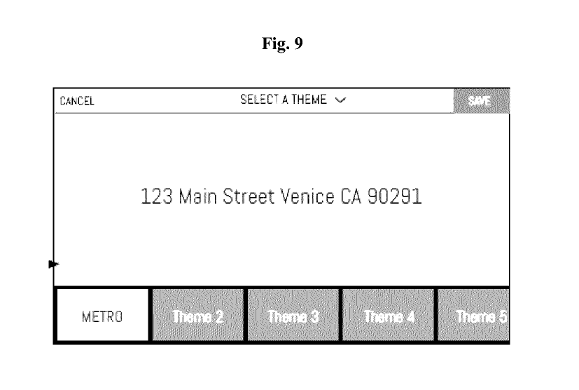

In some embodiments, the interactive scaffolded video template comprises tools to add theme to a video. In some embodiments, a theme is defaulted to be the first choice at outset. In some embodiments, a theme is changed by the user. Referring to FIG. 8, in a particular embodiment, a video authoring interface is provided to allow an agent to add and edit a theme to property videos. Referring to FIG. 9, in a particular embodiment, a video authoring interface is provided to allow an agent to edit and choose different themes for property videos.

In some embodiments, the interactive scaffolded video template comprises mandatory video sections for a property. In some embodiments, the interactive scaffolded video template comprises optional video sections for a property. In some embodiments, the interactive scaffolded video template comprises variable sections for a property, wherein the user indicates the number of video clips in the section. In some embodiments, the application comprises a separate interactive scaffolded video template for each of the listing types: property walkthrough, neighborhood tour, and neighborhood location.

In some embodiments, mandatory video sections for a property include, by way of non-limiting examples, introduction video sections, walk through video sections and wrap-up video sections. In some embodiments, mandatory video sections for a property have a minimum required number of clips/template positions to fill before they are “complete.” In some embodiments, optional video sections include variable number of clips up until a maximum number. In some embodiments, all mandatory video sections need to be “complete” and checked to ultimately submit the listing property. In some embodiments, if partial videos of mandatory video sections are filled, the video is considered “incomplete” and not checked.

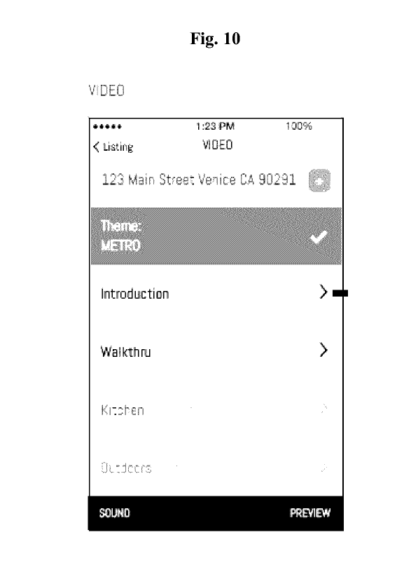

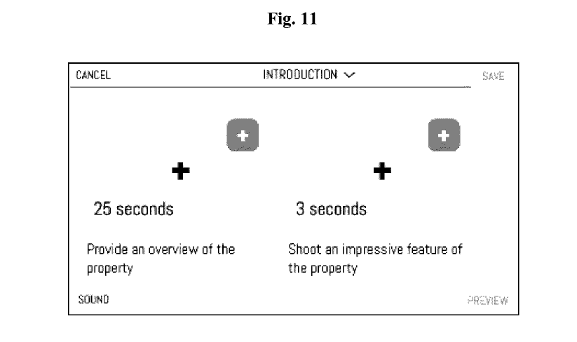

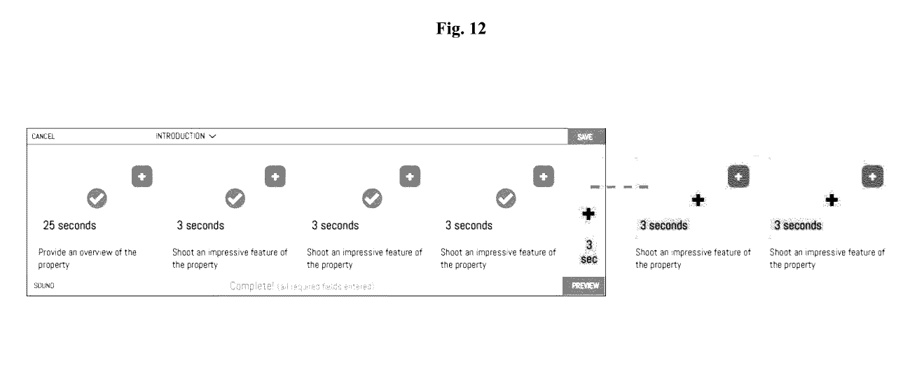

Referring to FIG. 10, in a particular embodiment, a video authoring interface is provided to allow an agent to add and edit introduction videos for a property. In some embodiments, the interactive scaffolded video template comprises tools to trim acquired video clips. In some embodiments, video acquisition is terminated at the end of the defined video length for each section. Referring to FIG. 11, in a particular embodiment, a video authoring interface is provided to allow an agent to shoot, add and edit introduction videos for a property, wherein an interactive scaffolded video template comprises introduction video sections including a 25-seconds overview video of the property and a 3-seconds video to show impressive features of the property. Referring to FIG. 12, in a particular embodiment, a video authoring interface is provided to allow an agent to shoot, add and edit introduction videos for a property, wherein an interactive scaffolded video template comprises optional introduction video sections showing additional impressive features of the property.

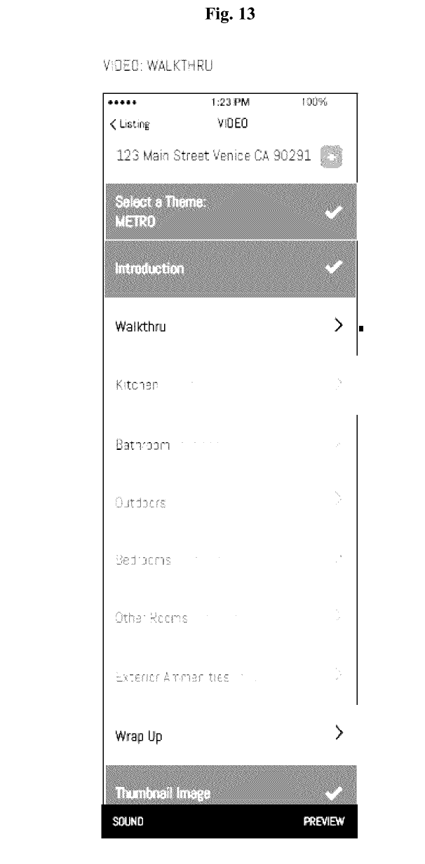

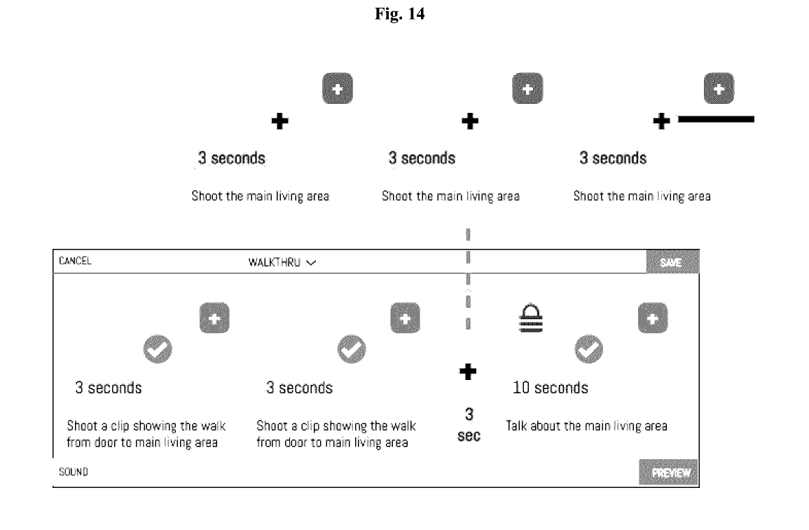

Referring to FIG. 13, in a particular embodiment, a video authoring interface is provided to allow an agent to add and edit mandatory walkthrough videos for a property. Referring to FIG. 14, in a particular embodiment, a video authoring interface is provided to allow an agent to shoot, add and edit mandatory walkthrough videos for a property, wherein an interactive scaffolded video template comprises mandatory and optional walkthrough video sections. In some embodiments, the property walkthrough scaffolded template comprises one or more of: introduction, walkthrough, kitchen, bathroom, outdoors, bedrooms, other rooms, exterior amenities, and wrap up.

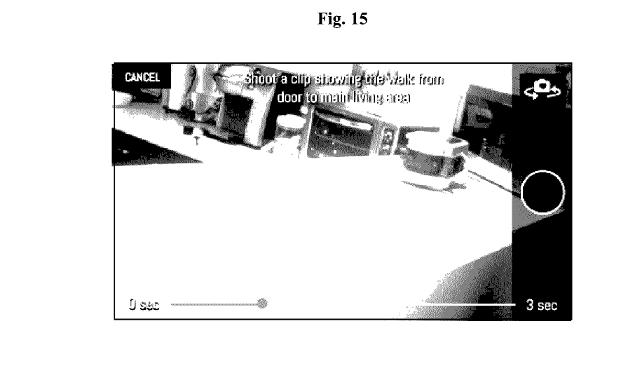

Referring to FIG. 15, in a particular embodiment, a video authoring interface is provided to allow an agent to shoot, add and edit mandatory walkthrough videos for a property, wherein a mobile phone camera is pressed and held to record a walkthrough video. In some embodiments, a timeline is displayed to show shooting progress. In some embodiments, after a user stops recording, he repositions and records again to complete the recording. In some embodiments, when a recording reaches the full time, the user is automatically taken back to the template view.

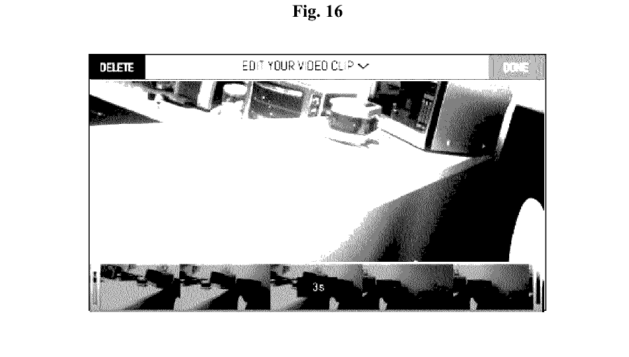

Referring to FIG. 16, in a particular embodiment, a video authoring interface is provided to allow an agent to shoot, add and edit mandatory walkthrough videos for a property, wherein a video clip is shortened and edited. In some embodiments, a user pinches timeline to shorten video clips. In some embodiments, a user is taken back to template view to start over when a clip is deleted.

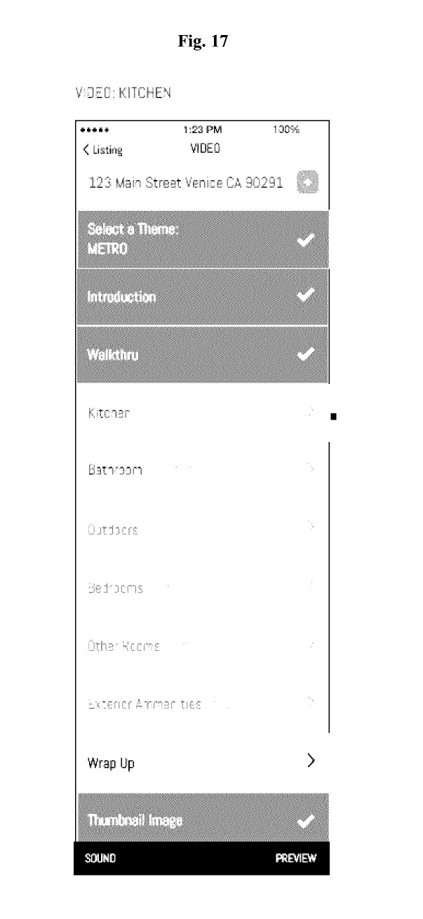

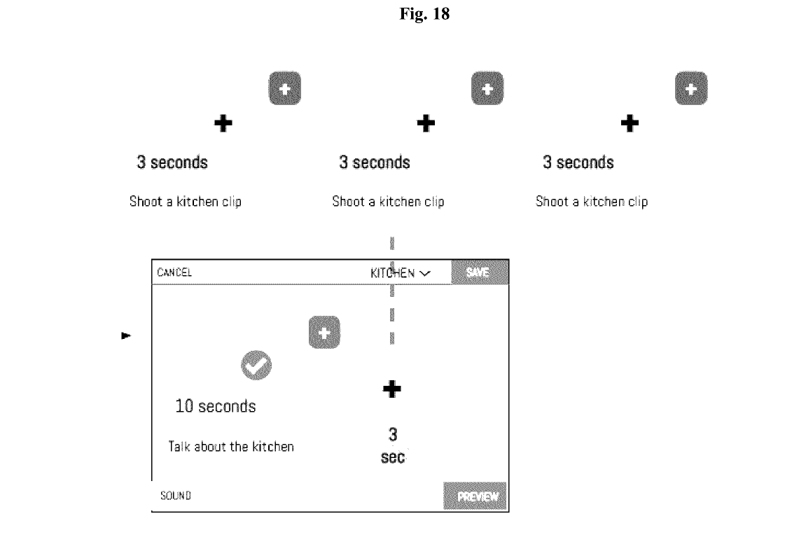

Referring to FIG. 17, in a particular embodiment, a video authoring interface is provided to allow an agent to shoot, add and edit optional videos for a property, including kitchen, bathroom, outdoors, bedrooms, other rooms and exterior amenities. Referring to FIG. 18, in a particular embodiment, a video authoring interface is provided to allow an agent to shoot, add and edit optional videos for a property, wherein an interactive scaffolded video template comprises kitchen video sections.

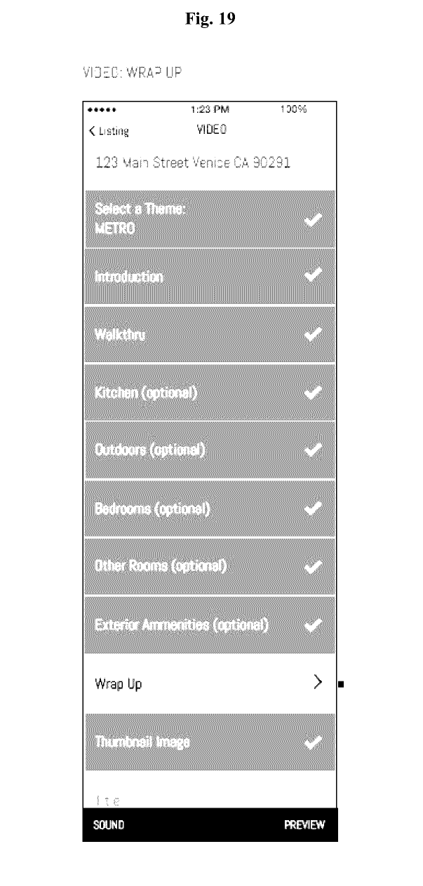

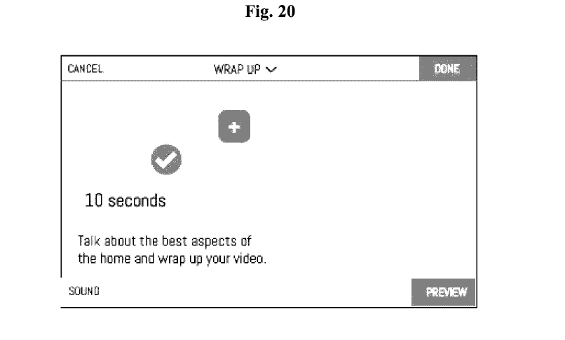

Referring to FIG. 19, in a particular embodiment, a video authoring interface is provided to allow an agent to add and edit mandatory wrap-up videos for a property. Referring to FIG. 20, in a particular embodiment, a video authoring interface is provided to allow an agent to shoot, add and edit mandatory wrap-up videos for a property, wherein an interactive scaffolded video template comprises wrap-up video sections wrapping up best aspects of the property.

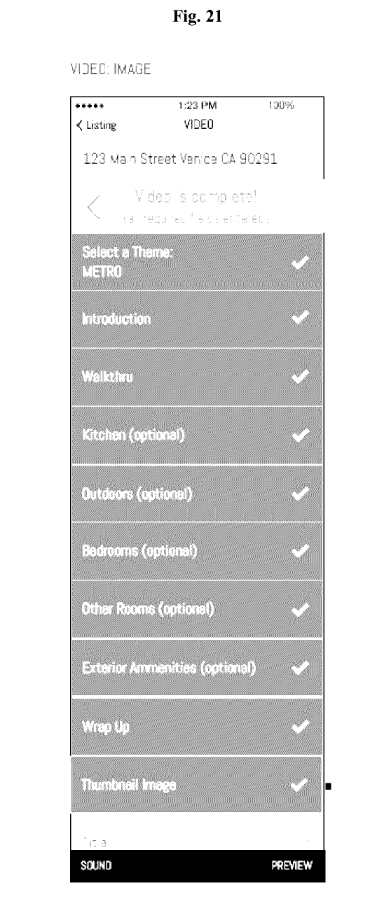

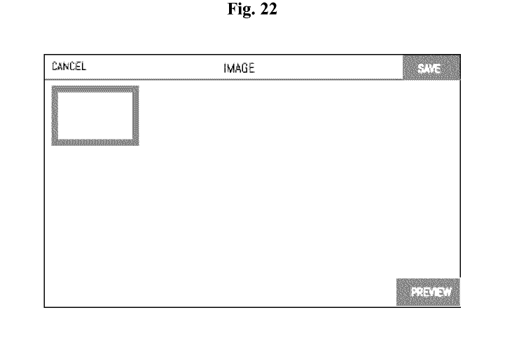

Referring to FIG. 21, in a particular embodiment, a video authoring interface is provided to allow an agent to add and edit thumbnail images for a property. Referring to FIG. 22, in a particular embodiment, a video authoring interface is provided to allow an agent to add and edit thumbnail images for a property, wherein an interactive scaffolded video template comprises thumbnail image cells for the editing. In some embodiments, a thumbnail image is automatically default selected after a video is added.

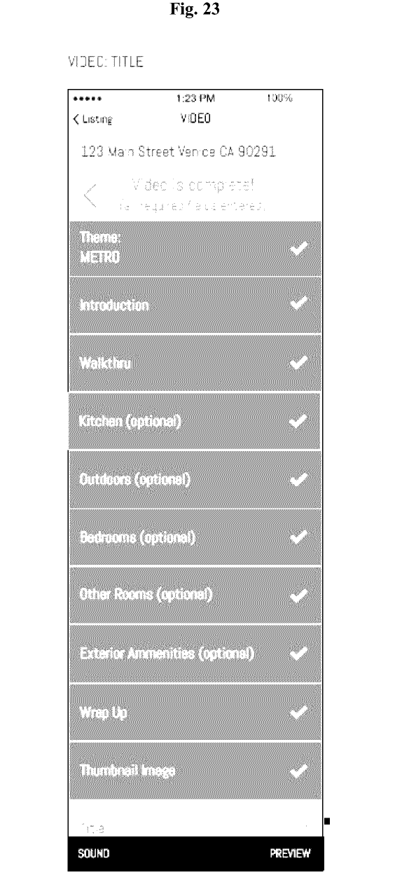

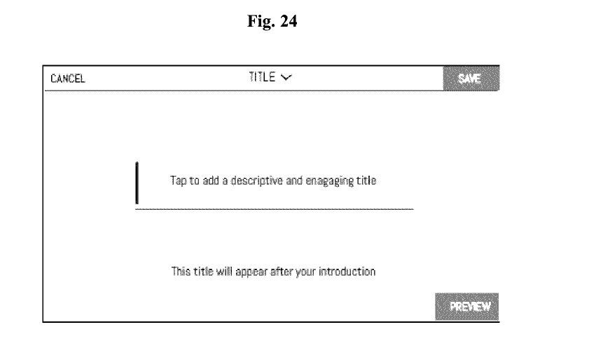

In some embodiments, a user has an option to add a creative title for the video sections. Referring to FIG. 23, in a particular embodiment, a video authoring interface is provided to allow an agent to add a video title for a property. Referring to FIG. 24, in a particular embodiment, a video authoring interface is provided to allow an agent to edit a video title for a property.

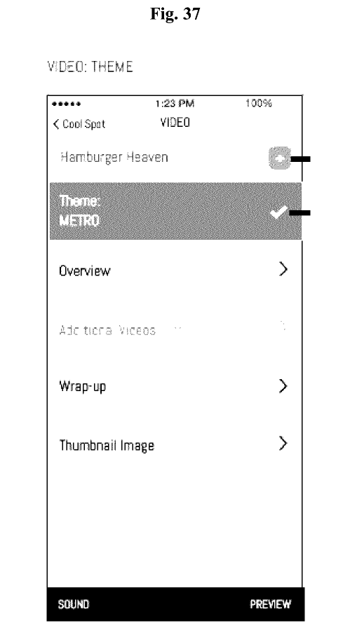

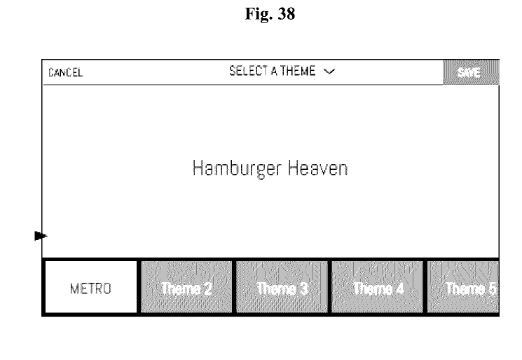

Referring to FIG. 36, in a particular embodiment, a listings and sales interface is provided to allow an agent to add and edit neighborhood cool spot videos. Referring to FIG. 37, in a particular embodiment, a video authoring interface is provided to allow an agent to add and edit a theme to a neighborhood cool spot video. Referring to FIG. 38, in a particular embodiment, a video authoring interface is provided to allow an agent to edit and choose different themes for a neighborhood cool spot video.

In some embodiments, the interactive scaffolded video template comprises mandatory video sections for a cool spot. In some embodiments, the interactive scaffolded video template comprises optional video sections for a cool spot. In some embodiments, the interactive scaffolded video template comprises variable sections for a cool spot, wherein the user indicates the number of video clips in the section. In some embodiments, the application comprises a separate interactive scaffolded video template for each of the listing types: property walkthrough, neighborhood tour, and neighborhood location.

In some embodiments, mandatory video sections for a cool spot include, by way of non-limiting examples, overview video sections and wrap-up video sections. In some embodiments, mandatory video sections for a cool spot have a minimum required number of clips/template positions to fill before they are “complete.” In some embodiments, optional video sections include variable number of clips up until a maximum number. In some embodiments, all mandatory video sections need to be “complete” and checked to ultimately submit the listing property. In some embodiments, if partial videos of mandatory video sections are filled, the video is considered “incomplete” and not checked.

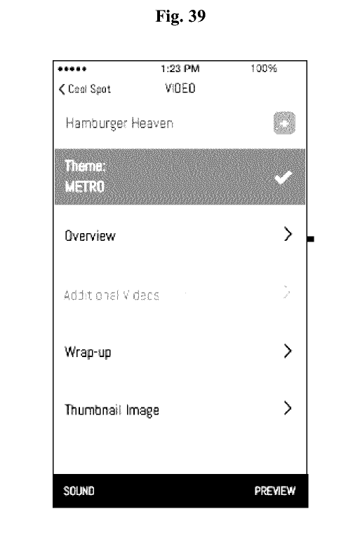

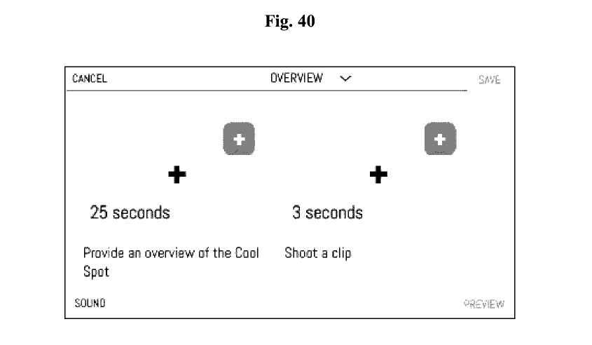

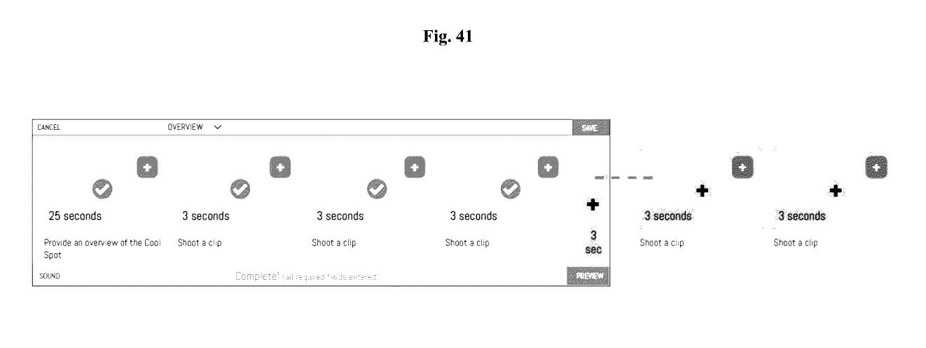

Referring to FIG. 39, in a particular embodiment, a video authoring interface is provided to allow an agent to add and edit overview videos for a neighborhood cool spot. In some embodiments, the interactive scaffolded video template comprises tools to trim acquired video clips. In some embodiments, video acquisition is terminated at the end of the defined video length for each section. Referring to FIG. 40, in a particular embodiment, a video authoring interface is provided to allow an agent to shoot, add and edit overview videos for a neighborhood cool spot, wherein an interactive scaffolded video template comprises overview video sections including a long 25-seconds overview video and a short 3-seconds overview video of the neighborhood cool spot. Referring to FIG. 41, in a particular embodiment, a video authoring interface is provided to allow an agent to shoot, add and edit overview videos for a neighborhood cool spot, wherein an interactive scaffolded video template comprises optional overview video sections showing additional overview of the neighborhood cool spot.

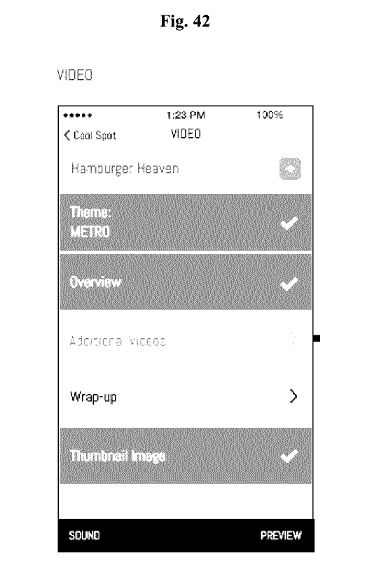

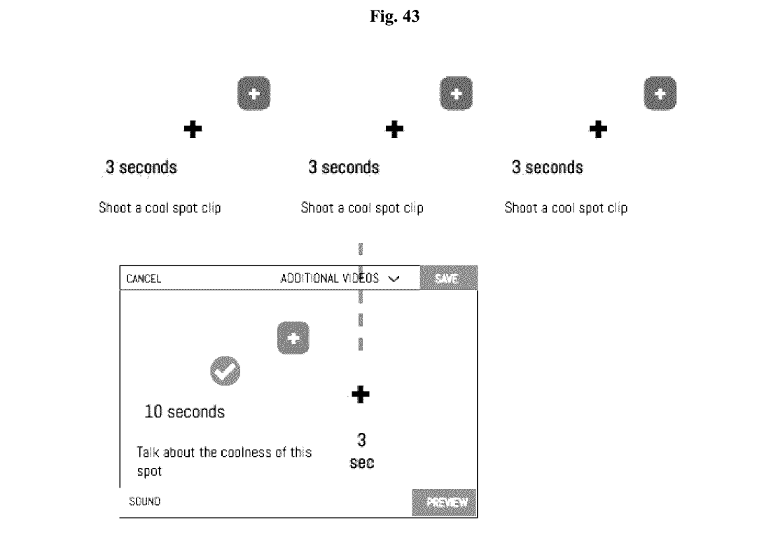

Referring to FIG. 42, in a particular embodiment, a video authoring interface is provided to allow an agent to add and edit optional additional videos for a neighborhood cool spot. Referring to FIG. 43, in a particular embodiment, a video authoring interface is provided to allow an agent to shoot, add and edit additional videos for a neighborhood cool spot, wherein an interactive scaffolded video template comprises optional neighborhood cool spot clip sections.

In some embodiments, the neighborhood location scaffolded template comprises one or more of: overview, additional videos, and wrap up.

In some embodiments, the interactive scaffolded video template comprises tools to add music to the video. In some embodiments, the interactive scaffolded video template comprises tools to add a voiceover to the video. In some embodiments, the interactive scaffolded video template comprises tools to create video with vocals. In some embodiments, the interactive scaffolded video template comprises tools to create sound track only video.

Account and Profile

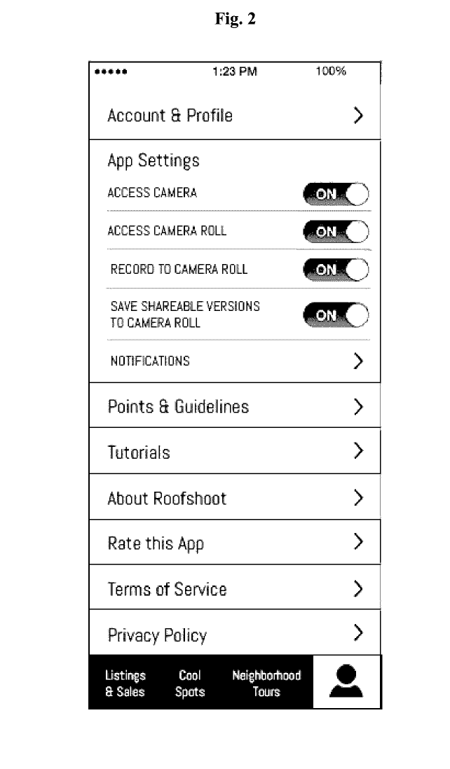

In some embodiments, the systems, media, and methods described herein include account and profile, or use of the same. In some embodiments, a software module is configured to present an interface for creating a user profile, the profile an agent profile or a consumer profile. Referring to FIG. 2, in a particular embodiment, an account and profile interface is provided to allow a user to manage app settings, account profiles, tutorials, rules, and app ratings, among others.

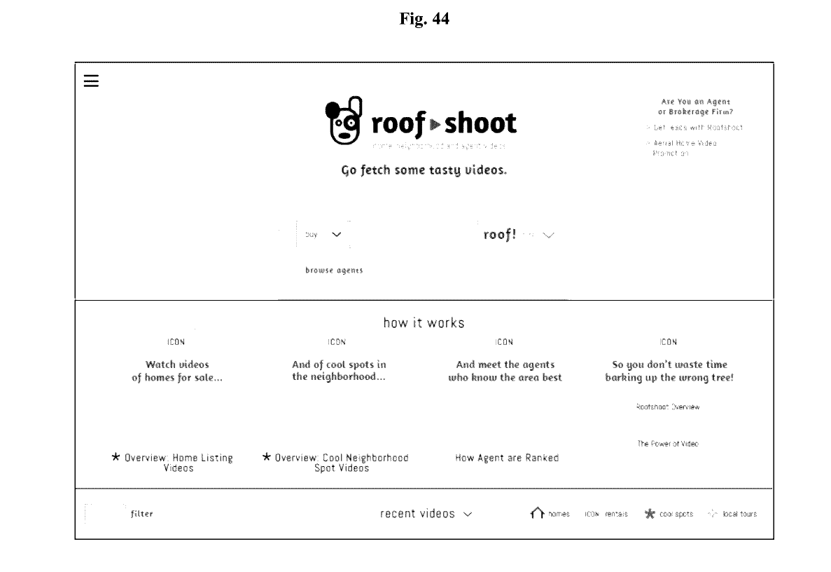

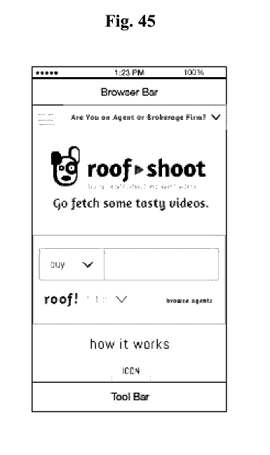

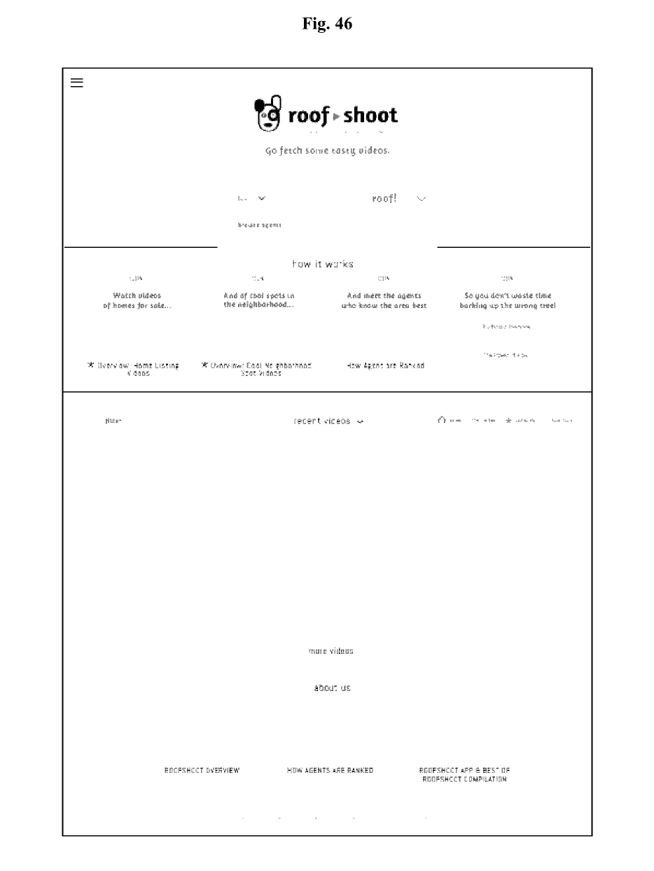

In some embodiments, a general user or an agent user starts from their homepage to browse and/or create listings and videos. Referring to FIG. 44, in a particular embodiment, a web-based homepage of a general user is provided to allow the user to browse listings, agents, videos and other information. Referring to FIG. 45, in a particular embodiment, a mobile homepage of a general user is provided to allow the user to browse listings, agents, videos and other information. Referring to FIG. 46, in a particular embodiment, a web-based homepage of a logged-in agent is provided to allow the agent to create and browse listings, agents, videos and other information.

In some embodiments, an agent profile is associated with her bio, listings, sales, cool spots, local tours, videos, and price opinions. In some embodiments, an agent profile is associated with a user review of the agent.

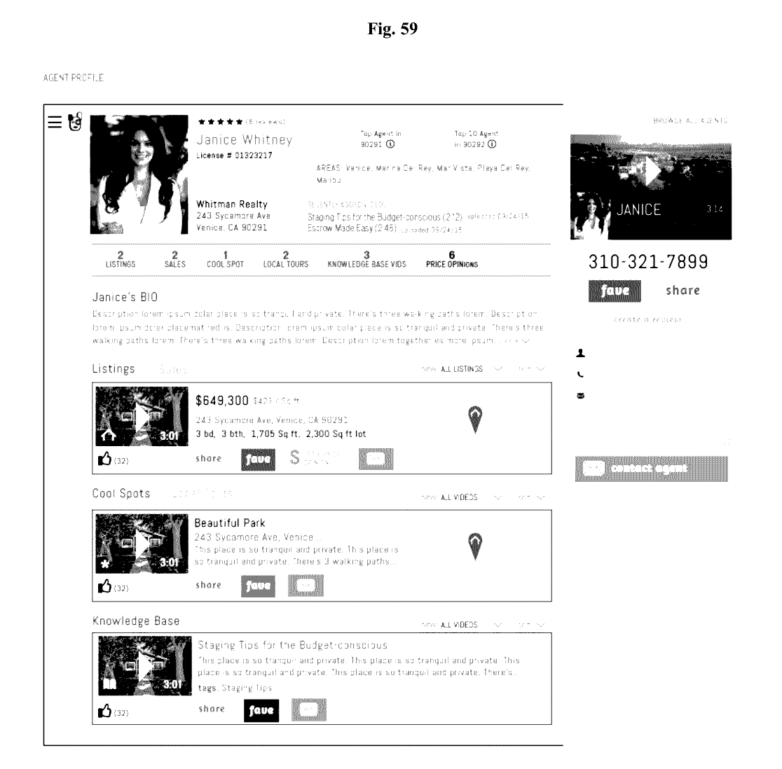

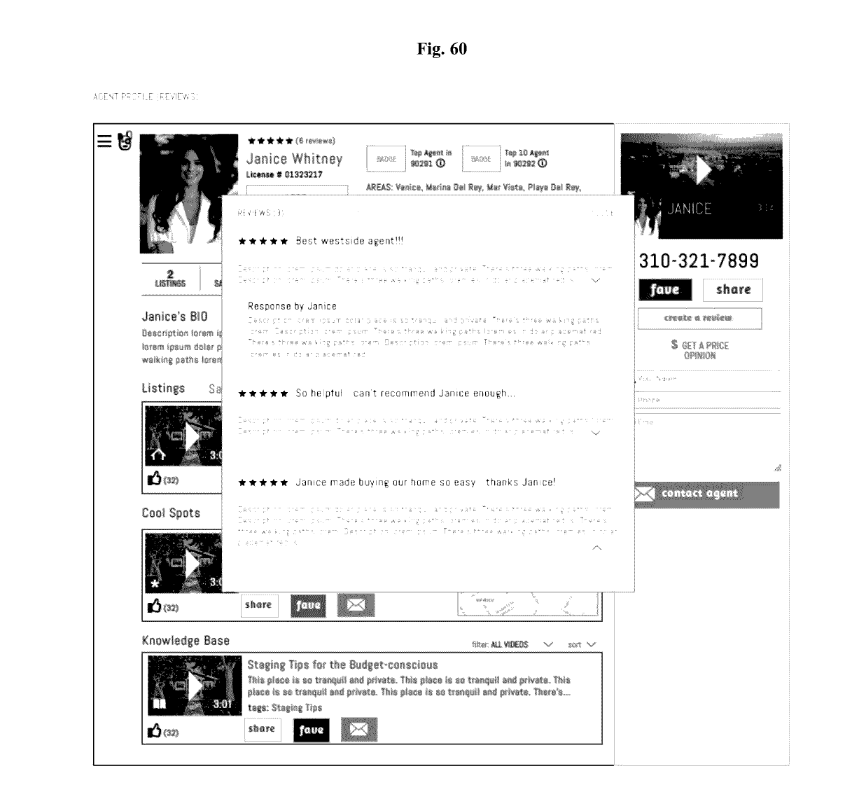

Referring to FIG. 59, in a particular embodiment, a detailed view of an agent profile is provided to display her bio, listings, sales, cool spots, local tours, knowledge-based videos and price opinions. Referring to FIG. 60, in a particular embodiment, a detailed view of an agent profile is provided to display reviews of the agent.

Map View

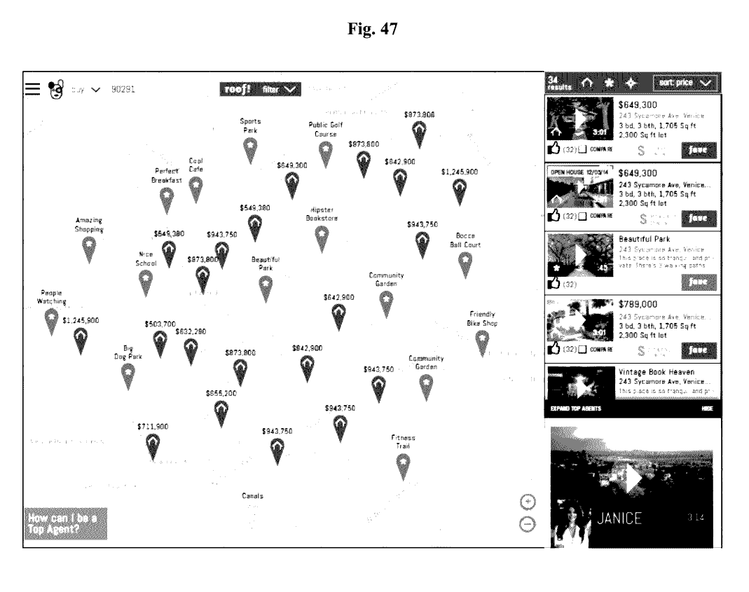

In some embodiments, the systems, media, and methods described herein include a map view, or use of the same. In some embodiments, a map view of properties, neighborhood cool spots and neighborhood tours is hereby provided. Referring to FIG. 47, in a particular embodiment, a web-based map and list view is presented for search results of properties, neighborhood cool spots and tours within a specified zip code. In some embodiments, a quick view is available by clicking or tapping an item on the map view. In some embodiments, a detailed view is available by clicking or tapping items on the map view. In some embodiments, a user view an item's associated videos within the map view of search results. In some embodiments, hovering over a map item causes the item to grow.

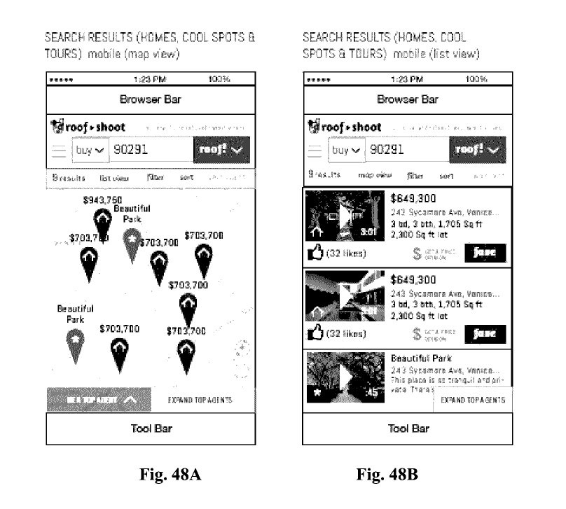

Referring to FIG. 48A, in a particular embodiment, a mobile map view is presented for search results of properties, neighborhood cool spots and tours within a specified zip code. Referring to FIG. 48B, in a particular embodiment, a mobile list view is presented for search results of properties, neighborhood cool spots and tours within a specified zip code.

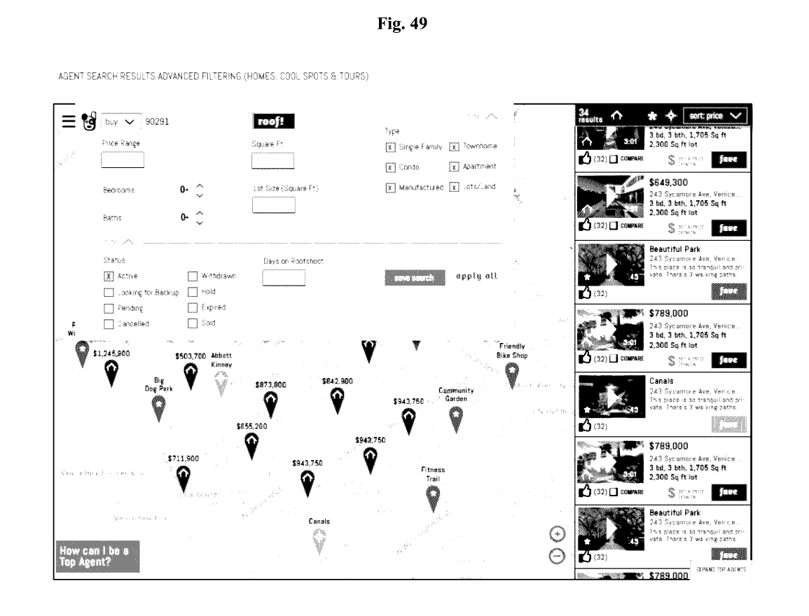

In some embodiments, a map view of search results are further refined with advanced filter parameters. In further embodiments, advanced filter parameters include, by way of non-limiting examples, price range, bedrooms, bathrooms, square footages, lot size, property types, listing status, and days in market. Referring to FIG. 49, in a particular embodiment, a web-based map and list view is presented for search results of properties, neighborhood cool spots and tours within a specified zip code with advanced filtering parameters.

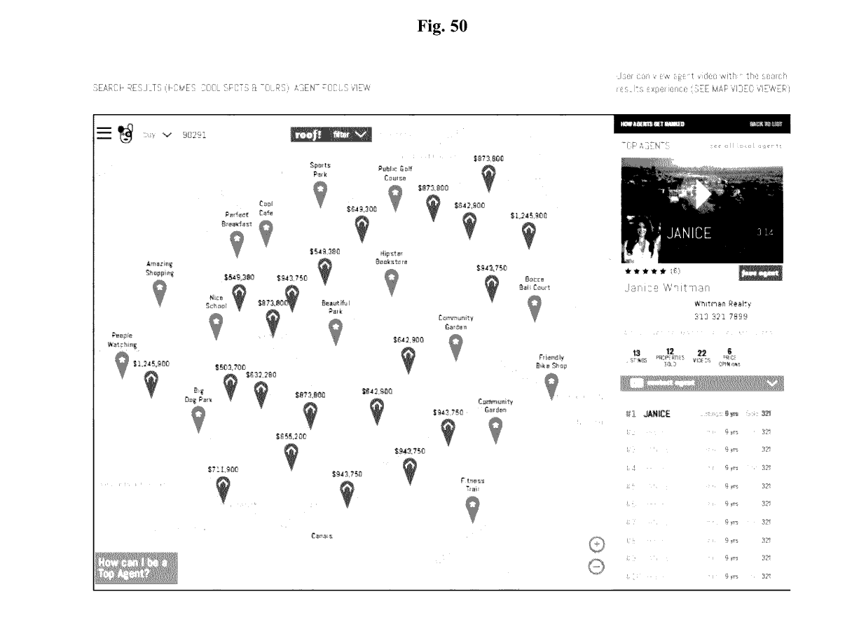

Referring to FIG. 50, in a particular embodiment, a web-based map view is presented for search results of properties, neighborhood cool spots and tours within a specified zip code, wherein the view is focused on listing agents.

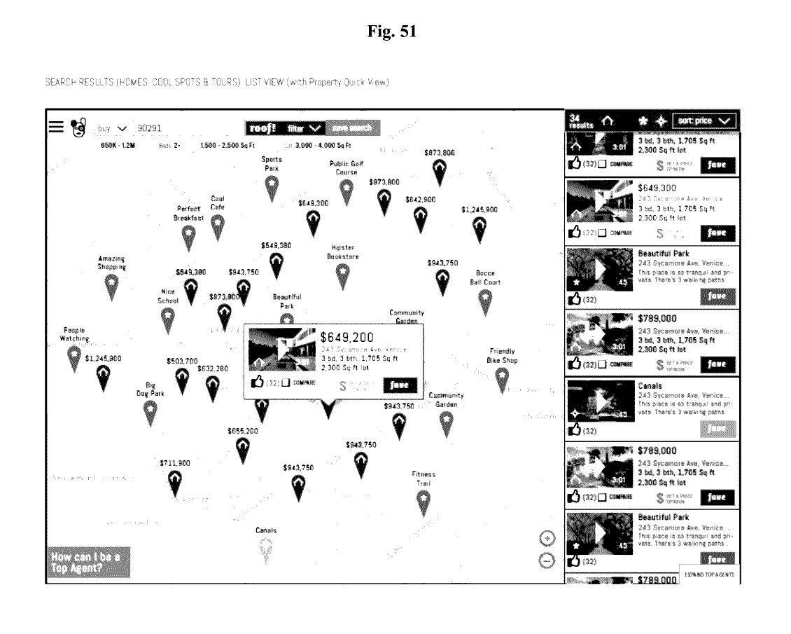

Referring to FIG. 51, in a particular embodiment, a web-based map and list view is presented for search results of properties, neighborhood cool spots and tours within a specified zip code, wherein a quick view is provided when a user clicks or taps on an item on the map.

Detailed View

In some embodiments, the systems, media, and methods described herein include detailed view, or use of the same. In some embodiments, a detailed view of a property include, by way of non-limiting examples, address, location, bathrooms, property type, price, videos, descriptions, the listing agent, and the listing agent's profile and information.

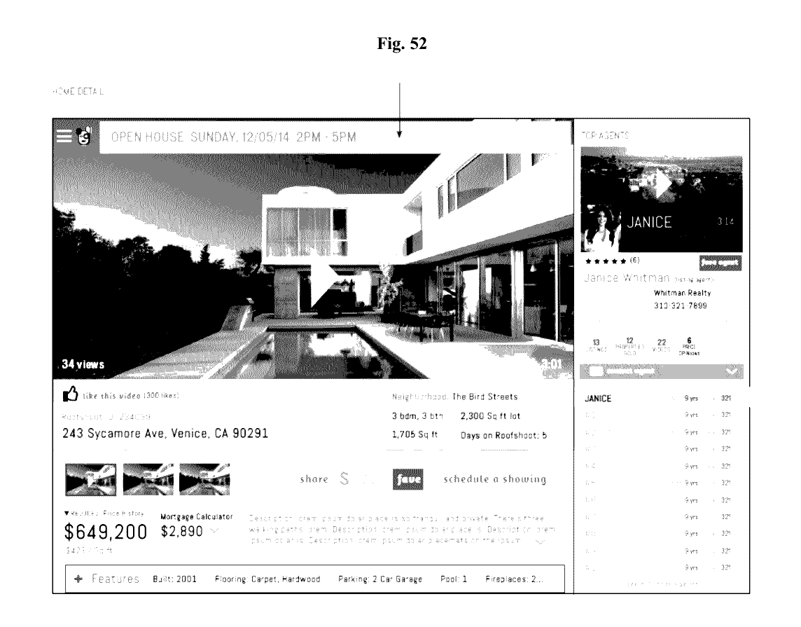

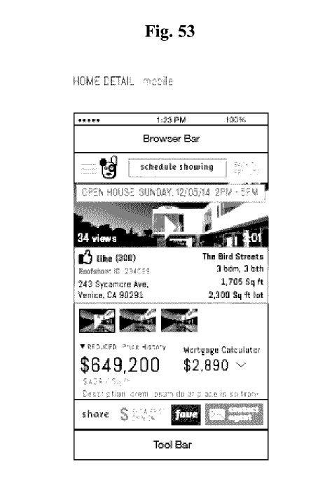

Referring to FIG. 52, in a particular embodiment, a web-based detailed view of a property is hereby provided. Referring to FIG. 53, in a particular embodiment, a mobile detailed view of a property is hereby provided.

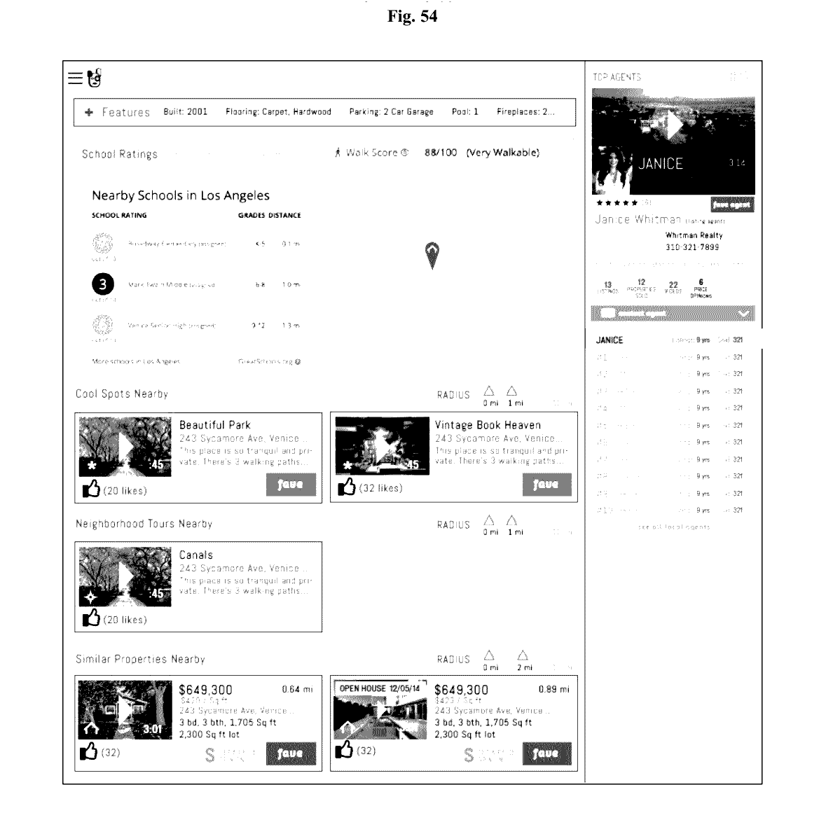

Referring to FIG. 54, in a particular embodiment, a web-based detailed view of a property is provided with the display of nearby schools, cool spots, neighborhood tours and similar properties.

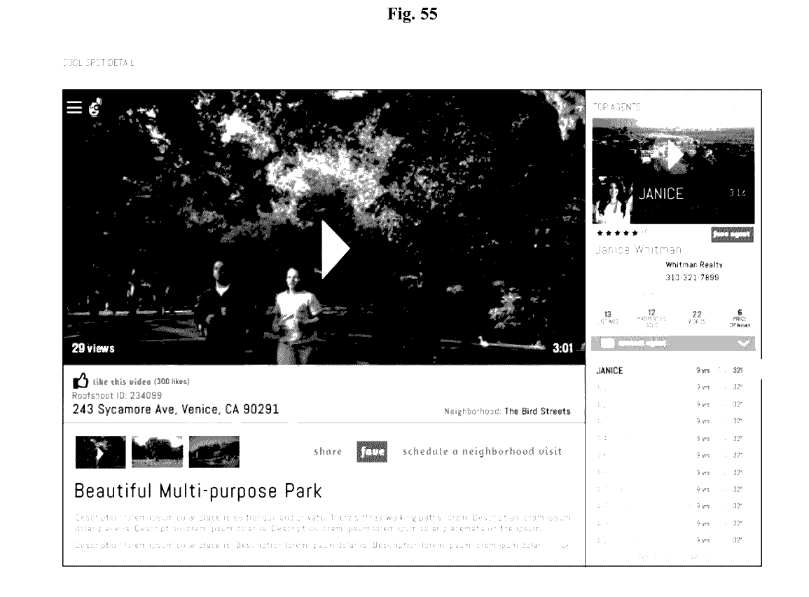

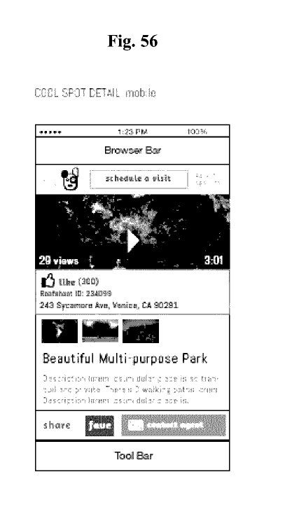

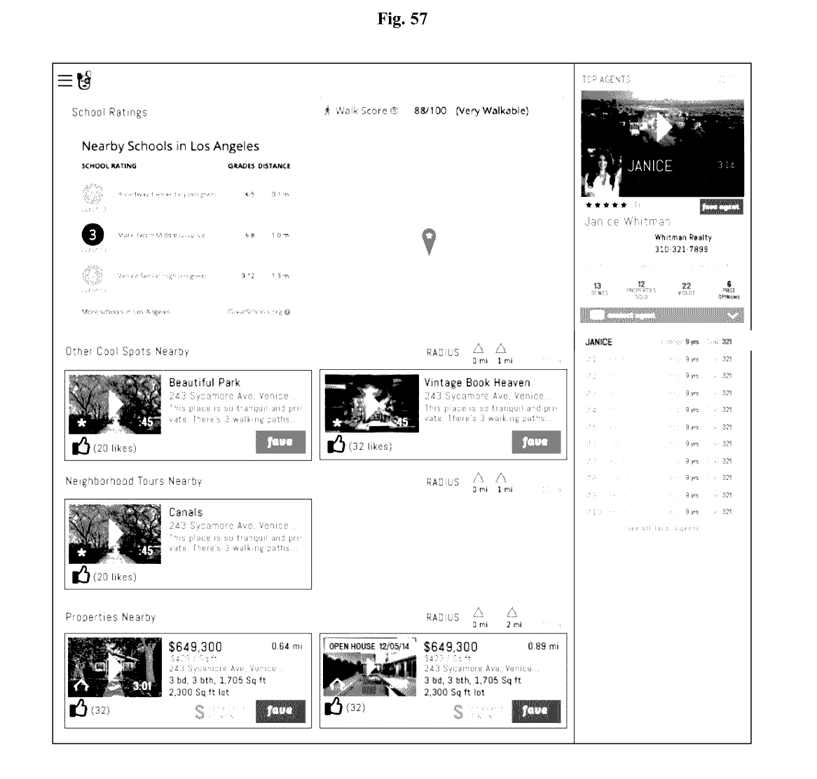

In some embodiments, a detailed view of a cool spot include, by way of non-limiting examples, address, location, videos, descriptions, and listing agent. Referring to FIG. 55, in a particular embodiment, a web-based detailed view of a neighborhood cool spot is hereby provided. Referring to FIG. 56, in a particular embodiment, a mobile detailed view of a neighborhood cool spot is hereby provided. Referring to FIG. 57, in a particular embodiment, a web-based detailed view of a neighborhood cool spot is hereby provided with the display of nearby schools, cool spots, neighborhood tours and properties.

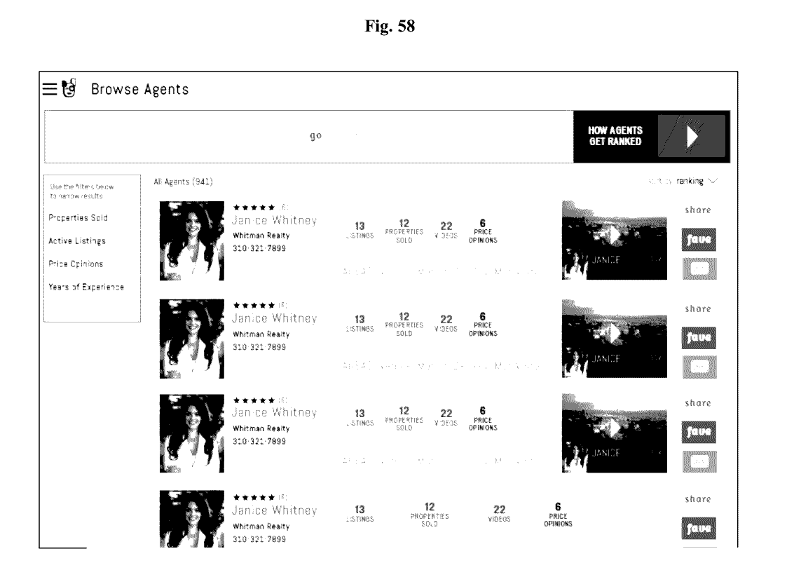

In some embodiments, a detailed view of an agent include, by way of non-limiting examples, name, contact information, properties sold, active listing, price opinions, and years of experience. Referring to FIG. 58, in a particular embodiment, an interface is provided to allow a user to search and browse agents. Referring to FIG. 59, in a particular embodiment, a detailed view of an agent profile is provided to display her bio, listings, sales, cool spots, local tours, knowledge-based videos and price opinions. Referring to FIG. 60, in a particular embodiment, a detailed view of an agent profile is provided to display reviews of the agent.

Agent Dashboard

In some embodiments, the systems, media, and methods described herein include an agent dashboard, or use of the same. In some embodiment, an agent dashboard includes, by way of non-limiting examples, activity feed, message center, price opinions, and saved searches. In some embodiment, starting from an agent dashboard, by way of non-limiting examples, the agent has the option of adding a new listing, adding a new cool spot, adding a new tour, adding to knowledge base, adding profile videos and referring a friend.

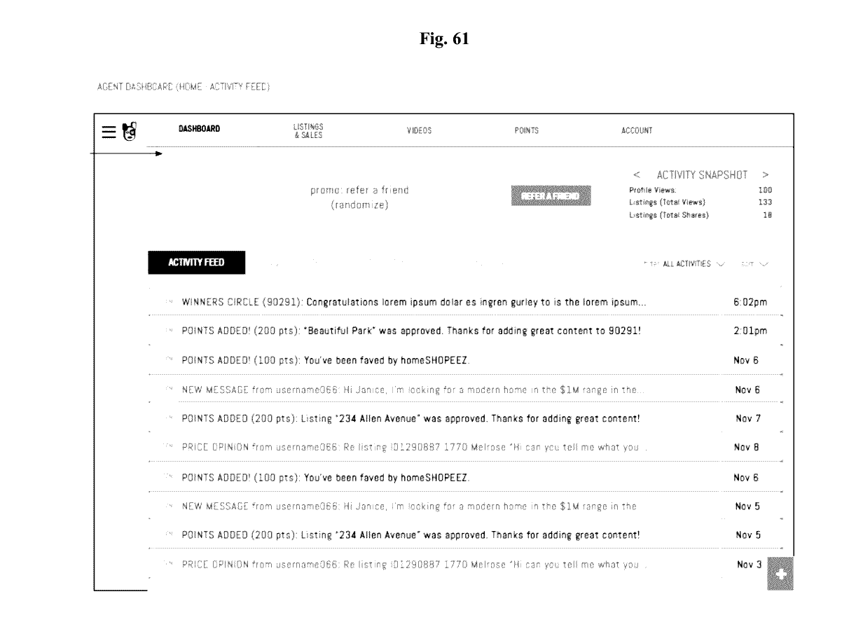

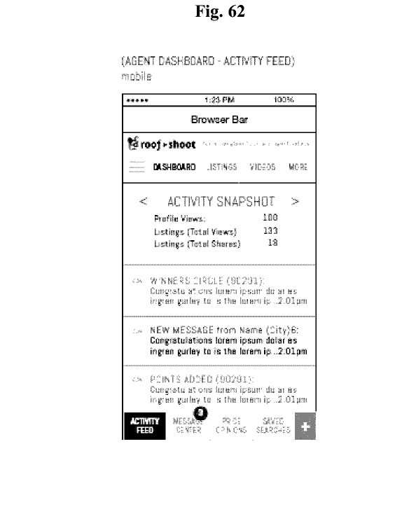

Referring to FIG. 61, in a particular embodiment, a web-based view of an agent dashboard is provided to display activity feed of the agent. Referring to FIG. 62, in a particular embodiment, a mobile view of an agent dashboard is provided to display activity feed of the agent.

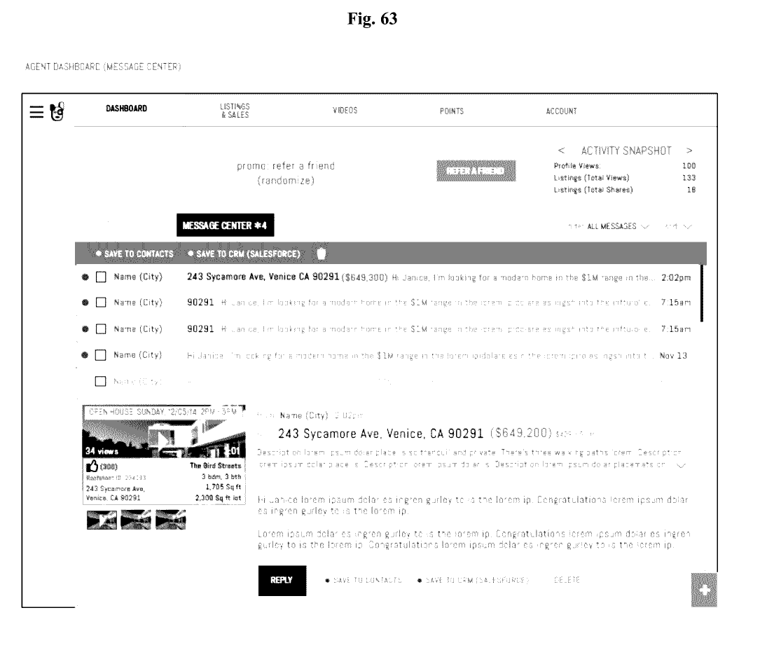

Referring to FIG. 63, in a particular embodiment, a web-based view of an agent dashboard is provided to display message center of the agent. In some embodiments, messages received by the agent include, by way of non-limiting examples, property-specific message, cool spot/tour-specific message, price opinion from property detail or map list, schedule showing request, and general questions from profile.

In some embodiments, the application further comprises an interface for allowing a first user to request a price opinion for a listed property and an interface for a second user to submit a price opinion for the listed property. In some embodiments, points are awarded to a user providing a price opinion. In further embodiments, points are awarded to a user when a price opinion is approved.

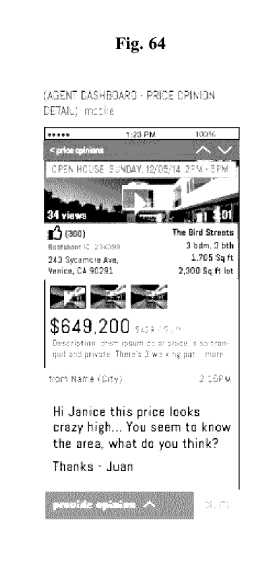

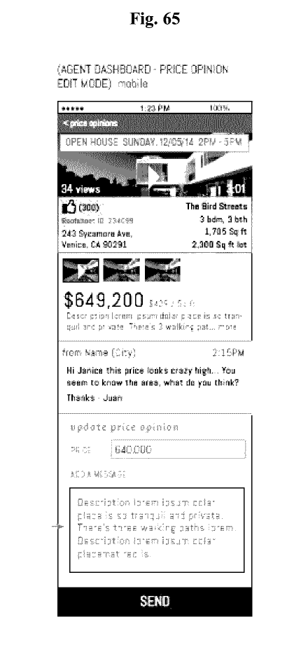

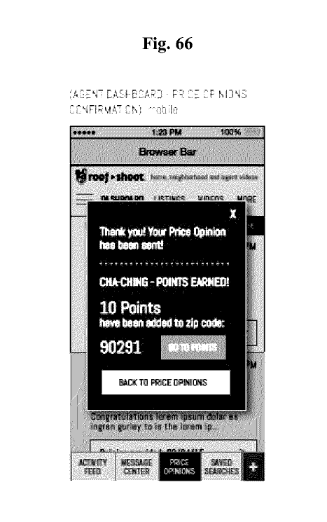

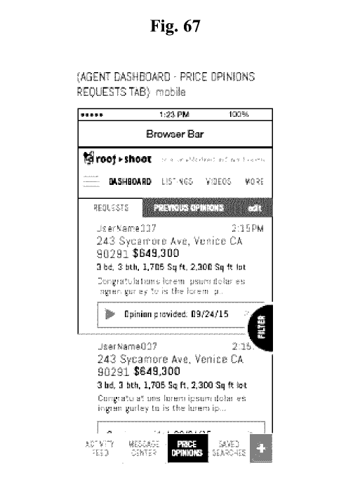

Referring to FIG. 64, in a particular embodiment, a mobile view of an agent dashboard is provided to display the agent's price opinions. Referring to FIG. 65, in a particular embodiment, a mobile view of an agent dashboard is provided to allow the agent to create, update and submit price opinions. Referring to FIG. 66, in a particular embodiment, a mobile view of an agent dashboard is provided to display points earned by the agent after submitting price opinions. Referring to FIG. 67, in a particular embodiment, a mobile view of an agent dashboard is provided to display price opinions requests.

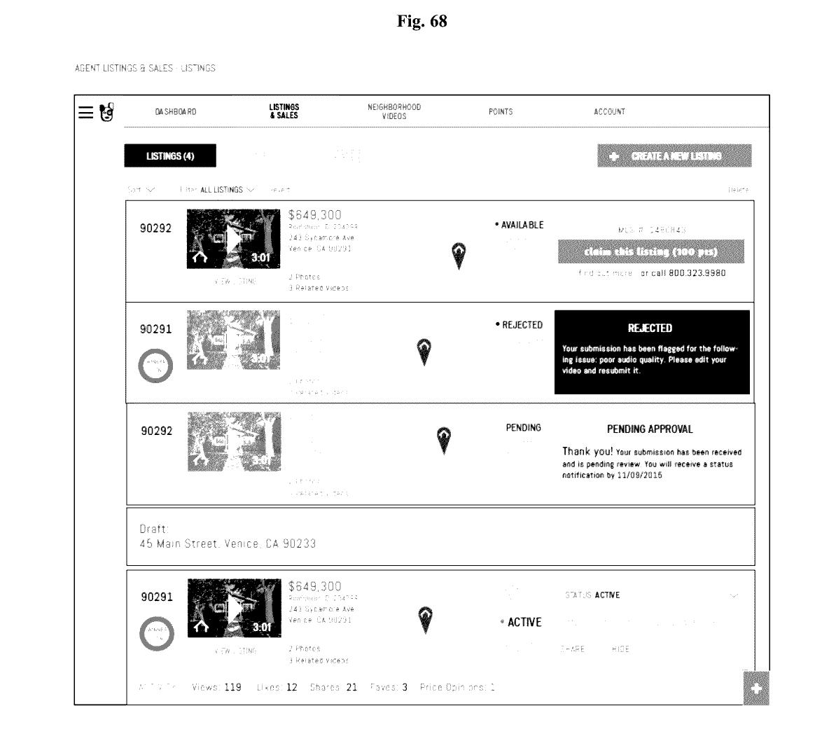

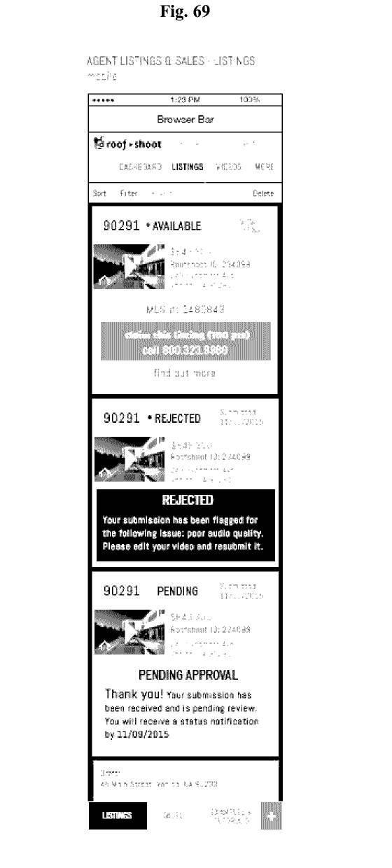

Referring to FIG. 68, in a particular embodiment, a web-based detailed view of an agent's listings and sales is hereby provided. Referring to FIG. 69, in a particular embodiment, a mobile detailed view of an agent's listings and sales is hereby provided.

Buyer's Dashboard

In some embodiments, the systems, media, and methods described herein include a buyer's dashboard, or use of the same. In some embodiments, a buyer's dashboard gives a buyer a starting page after he logs in. In some embodiments, a buyer's dashboard includes, by way of non-limiting examples, recommended properties, recently viewed items, price opinions, and saved searches.

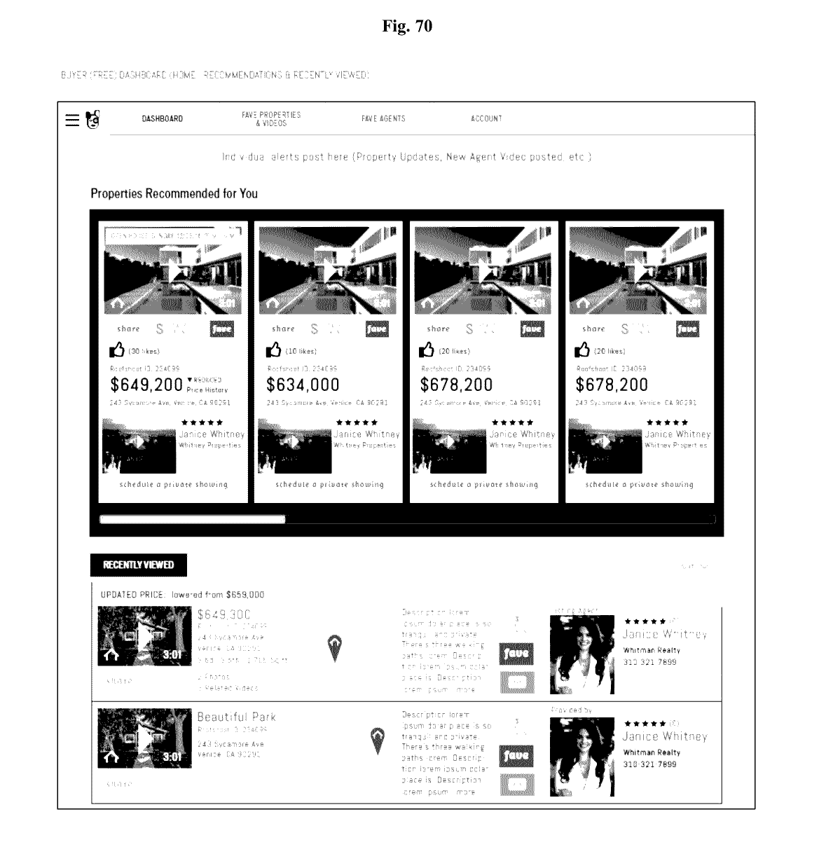

Referring to FIG. 70, in a particular embodiment, an interface of a buyer's dashboard is provided to display the buyer's recently viewed listings and recommended properties for the buyer.

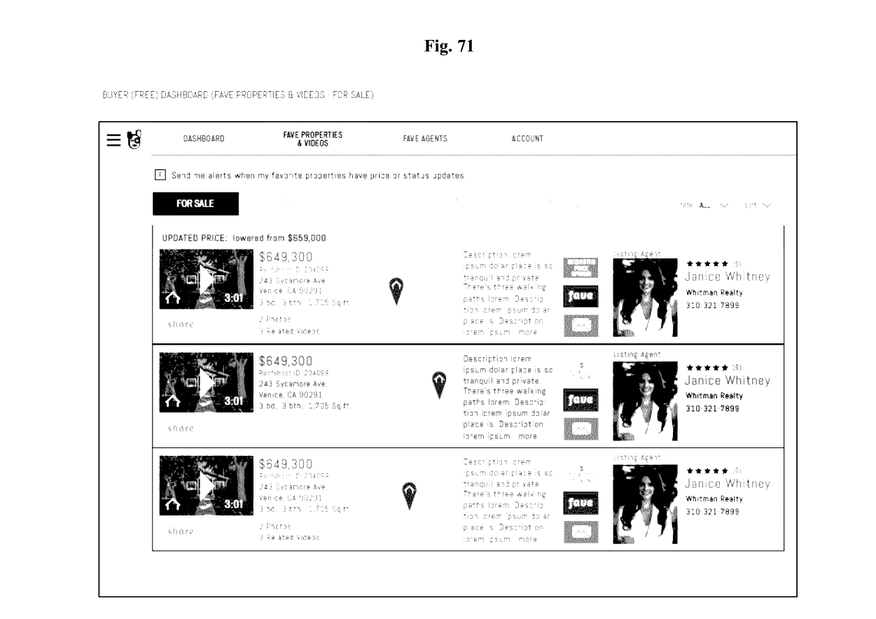

Referring to FIG. 71, in a particular embodiment, an interface of a buyer's dashboard is provided to display the buyer's favorite properties and videos.

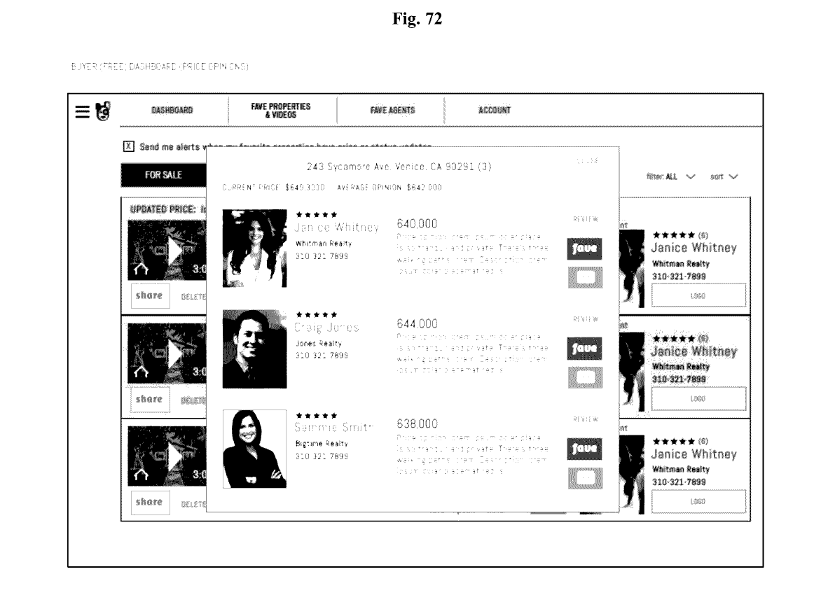

Referring to FIG. 72, in a particular embodiment, an interface of a buyer's dashboard is provided to display price opinions of the buyer's viewed properties.

Price Opinions

In some embodiments, the systems, media, and methods described herein include price opinions, or use of the same. In some embodiments, the application further comprises an interface for allowing a first user to request a price opinion for a listed property and an interface for a second user to submit a price opinion for the listed property. In some embodiments, points are awarded to a user providing a price opinion.

Referring to FIG. 64, in a particular embodiment, a mobile view of an agent dashboard is provided to display the agent's price opinions. Referring to FIG. 65, in a particular embodiment, a mobile view of an agent dashboard is provided to allow the agent to create, update and submit price opinions. Referring to FIG. 66, in a particular embodiment, a mobile view of an agent dashboard is provided to display points earned by the agent after submitting price opinions. Referring to FIG. 67, in a particular embodiment, a mobile view of an agent dashboard is provided to display price opinions requests.

Referring to FIG. 72, in a particular embodiment, an interface of a buyer's dashboard is provided to display price opinions of the buyer's viewed properties.

Points

In some embodiments, the systems, media, and methods described herein include points, or use of the same. In some embodiments, a software module is configured to award points for user activity within the application, the user activity comprising creation of video listings, the points used to allocate user promotions.

In some embodiments, the points are awarded for one or more of: creating a profile, creating a profile video, creating a property walkthrough video, creating a neighborhood tour video, creating a neighborhood location video, providing a price opinion, and marking a video listing as sold. In some embodiments, the more points an agent is awarded, the higher the agent is ranked in the agent listing. In further embodiments, the points are only awarded to a user when the submitted videos, listings and price opinions get approved.

Referring to FIG. 66, in a particular embodiment, a mobile view of an agent dashboard is provided to display points earned by the agent after submitting price opinions.

Digital Processing Device

In some embodiments, the systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® P54®, Microsoft Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

Non-Transitory Computer Readable Storage Medium

In some embodiments, the systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

Computer Program

In some embodiments, the systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML5, Apple® QuickTime®, Microsoft Silverlight®, Java™, and Unity®.

Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

Software Modules

In some embodiments, the systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

Databases

In some embodiments, the systems, media, and methods disclosed herein include one or more databases, or use of the same. In view of the disclosure provided herein, those of skill in the art will recognize that many databases are suitable for storage and retrieval of property, video, and user information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

1. A computer-implemented system for gamified real estate video listing comprising:
a) a digital processing device comprising an operating system configured to perform executable instructions and a memory;
b) a computer program including instructions executable by the digital processing device to create a video listing application comprising:
i) a software module configured to present an interface for creating a video listing, the video listing of a type selected from: property walkthrough, neighborhood tour, or neighborhood location, the interface comprising an interactive scaffolded video template comprising a plurality of sequenced video sections, each section defining a subject matter and a pre-defined video length and, upon activation of the video template by a user, facilitating acquisition of a corresponding video clip, wherein the video template accepts recording real-time video via the processing device or an external device in communication with the processing device from the premise of the defined subject matter, and selecting a pre-recorded video previously taken from the premise of the defined subject matter from a storage, wherein the video template comprises mandatory and optional video sections, wherein completion of all mandatory video sections is required to submit a video listing, and wherein video acquisition is automatically terminated by the video listing application at the end of the pre-defined video length for each section;
ii) a software module configured to present a map view interface comprising video listings;
iii) a software module configured to present an interface for allowing a first user to request a price opinion for a listed property, a second user to submit a price opinion for the listed property based on the request, and a user to view price opinions on the listed property and an average price opinion based on all submitted price opinions; and
iv) a software module configured to promote users for user activity within the application, the user activity eligible for promotion comprising one or more of: creating a profile, creating a profile video, creating a property walkthrough video, creating a neighborhood tour video, creating a neighborhood location video, providing a price opinion, and marking a video listing as sold.

2. The system of claim 1, wherein the application further comprises a software module configured to present an interface for creating a user profile, the profile an agent profile or a consumer profile.

3. (canceled)

4. (canceled)

5. (canceled)

6. The system of claim 1, wherein the interactive scaffolded video template comprises variable sections, wherein the user indicates the number of video clips in the section.

7. The system of claim 1, wherein the application comprises a separate interactive scaffolded video template for each of the listing types: property walkthrough, neighborhood tour, and neighborhood location.

8. The system of claim 7, wherein the property walkthrough scaffolded template comprises one or more of: introduction, walkthrough, kitchen, bathroom, outdoors, bedrooms, other rooms, exterior amenities, and wrap up.

9. The system of claim 7, wherein the neighborhood location scaffolded template comprises one or more of: overview, additional videos, and wrap up.

10. The system of claim 1, wherein the interactive scaffolded video template comprises tools to trim acquired video clips.

11. The system of claim 1, wherein the interactive scaffolded video template comprises tools to add a theme to the video.

12. The system of claim 1, wherein the interactive scaffolded video template comprises tools to add music to the video.

13. The system of claim 1, wherein the interactive scaffolded video template comprises tools to add a voiceover to the video.

14. (canceled)

15. (canceled)

16. Non-transitory computer-readable storage media encoded with a computer program including instructions executable by a processor to create an application for gamified real estate video listing comprising:
a) a software module configured to present an interface for creating a video listing, the video listing of a type selected from: property walkthrough, neighborhood tour, or neighborhood location, the interface comprising an interactive scaffolded video template comprising a plurality of sequenced video sections, each section defining a subject matter and a pre-defined video length and, upon activation of the video template by a user, facilitating acquisition of a corresponding video clip, wherein the video template accepts recording real-time video via the processing device or an external device in communication with the processing device from the premise of the defined subject matter, and selecting a pre-recorded video previously taken from the premise of the defined subject matter from a storage, wherein the video template comprises mandatory and optional video sections, wherein completion of all mandatory video sections is required to submit a video listing, and wherein video acquisition is automatically terminated by the video listing application at the end of the pre-defined video length for each section;
b) a software module configured to present a map view interface comprising video listings;
c) a software module configured to present an interface for allowing a first user to request a price opinion for a listed property, a second user to submit a price opinion for the listed property based on the request, and a user to view price opinions on the listed property and an average price opinion based on all submitted price opinions; and
d) a software module configured to promote users for user activity within the application, the user activity eligible for promotion comprising one or more of: creating a profile, creating a profile video, creating a property walkthrough video, creating a neighborhood tour video, creating a neighborhood location video, providing a price opinion, and marking a video listing as sold.

17. The media of claim 16, wherein the application further comprises a software module configured to present an interface for creating a user profile, the profile an agent profile or a consumer profile.

18. (canceled)

19. (canceled)

20. The media of claim 16, wherein the interactive scaffolded video template comprises variable sections, wherein the user indicates the number of video clips in the section.

21. The media of claim 16, wherein the application comprises a separate interactive scaffolded video template for each of the listing types: property walkthrough, neighborhood tour, and neighborhood location.

22. (canceled)

23. (canceled)

24. A computer-implemented method of providing high quality, gamified real estate video listings comprising:
a) providing, by a computer, an interface for creating a video listing, the video listing of a type selected from: property walkthrough, neighborhood tour, or neighborhood location, the interface comprising an interactive scaffolded video template comprising a plurality of sequenced video sections, each section defining a subject matter and a pre-defined video length and, upon activation of the video template by a user, facilitating acquisition of a corresponding video clip, wherein the video template accepts recording real-time video via the processing device or an external device in communication with the processing device from the premise of the defined subject matter, and selecting a pre-recorded video previously taken from the premise of the defined subject matter from a storage, wherein the video template comprises mandatory and optional video sections, wherein completion of all mandatory video sections is required to submit a video listing, and wherein video acquisition is automatically terminated by the video listing application at the end of the pre-defined video length for each section;
b) providing, by the computer, a map view interface comprising video listings;
c) providing, by a computer, an interface for allowing a first user to request a price opinion for a listed property, a second user to submit a price opinion for the listed property based on the request, and a user to view price opinions on the listed property and an average price opinion based on all submitted price opinions; and
d) promoting users, by the computer, for user activity, the user activity eligible for promotion comprising one or more of: creating a profile, creating a profile video, creating a property walkthrough video, creating a neighborhood tour video, creating a neighborhood location video, providing a price opinion, and marking a video listing as sold.

25. The method of claim 24, further comprising providing, by the computer, an interface for creating a user profile, the profile an agent profile or a consumer profile.

26. (canceled)

27. (canceled)

28. The method of claim 24, wherein the application comprises a separate interactive scaffolded video template for each of the listing types: property walkthrough, neighborhood tour, and neighborhood location.

29. (canceled)

30. (canceled)
